(19) United States
(12) Patent Application Publication
(10) Pub. No.: US 2016/0266938 A1
(43) Pub. Date: Sep. 15, 2016

(54) LOAD BALANCING FUNCTION DEPLOYING METHOD AND APPARATUS

(71) Applicant: FUJITSU LIMITED, Kawasaki-shi (JP)

(72) Inventor: KAZUHIRO SUZUKI, Kawasaki (JP)

(73) Assignee: FUJITSU LIMITED, Kawasaki-shi (JP)

(21) Appl. No.: 15/051,894

(22) Filed: Feb. 24, 2016

(30) Foreign Application Priority Data
Mar. 13, 2015 (JP) 2015-050652

(51) Int. Cl. G06F 9/50; G06F 9/455

(52) U.S. Cl. CPC G06F 9/5083; G06F 9/45558; G06F 2009/45562; G06F 2009/45579

(57) ABSTRACT

A computer receives a deployment instruction for a new virtual machine that controls communication between a first virtual machine, which has a function for communicating with at least one virtual machine, and a second virtual machine. The computer creates a second driver corresponding to a first driver, which is provided in the first virtual machine and is used for communication with the second virtual machine, and a third driver, which is used for communication between the new virtual machine and the first virtual machine, in the new virtual machine, and connects the second driver and the third driver using a virtual bridge. The computer then invalidates the first driver and validates the second driver after enabling the second driver to use a buffer region used by the first driver.

### CROSS-REFERENCE TO RELATED APPLICATION

This application is based upon and claims the benefit of priority of the prior Japanese Patent Application No. 2015-050652, filed on Mar. 13, 2015, the entire contents of which are incorporated herein by reference.

### FIELD

The present embodiments discussed herein are related to a load balancing function deploying method and apparatus.

### BACKGROUND

One common computing technique is virtualization, where one or more virtual computers (also called “virtual machines”) are created on a physical computer (or “physical machine”). Each virtual machine runs an operating system (OS). As one example, a computer that is running a virtual machine executes software (sometimes called a “hypervisor”) that assigns computer resources, such as the CPU (Central Processing Unit) and RAM (Random Access Memory), to the virtual machine. The OS of each virtual machine performs control, such as scheduling of an application program, within the range of the assigned resources.

In recent years, services that provide computer resources and a usage environment for virtual machines via a network have also come into use. IaaS (Infrastructure as a Service) is one example of a model for providing such services.

As with regular computers, patches for security measures and functional upgrades for software, such as an OS and applications, are also issued for virtual machines. When a patch is installed, the provision of services may be temporarily stopped due to a restart of a virtual machine and/or software. Here, by designing a system with redundancy using a load balancing function for a plurality of virtual machines that provide the same services, it is possible, even when one of the virtual machines temporarily stops, to have other virtual machines continue the provision of services to users. This method of updating is sometimes referred to as a “rolling update”.

When a plurality of virtual machines are deployed on a single physical machine, it is possible to have a virtual machine dedicated to management purposes (referred to as a “management OS” or a “host OS”) manage access to devices by other virtual machines (sometimes referred to as “guest OSs”). According to one proposed technology, the management OS performs load balancing for a plurality of guest OSs. With this technology, when the management OS has received data, the guest OS to which the data is to be distributed is decided based on the identification information of the guest OSs, and the data is sent from a backend driver unit of the management OS to a frontend driver unit of the guest OS that is the distribution destination.

Note that there is also a proposed technology where, for a system in which a plurality of OSs are executed by a plurality of LPAR (Logical Partitions) in one information processing apparatus, a representative LPAR relays communication between an external network and the other LPAR.

See, for example, the following documents:

Japanese Laid-Open Patent Publication No. 2010-66931

Japanese Laid-Open Patent Publication No. 2007-110240

Even when a virtual machine for load balancing is not deployed in advance, there are situations, such as when updating software for existing virtual machines, where it is desirable to newly deploy a virtual machine that performs load balancing. This leads to the issue of how to dynamically deploy a virtual machine that performs load balancing while maintaining the communication between virtual machines and clients.

As one example, it would be conceivable to deploy a virtual machine that performs load balancing so as to take over the IP (Internet Protocol) address of a virtual machine that is providing work services. In this case, access from a client that designates the same IP address as before deployment can be received by the virtual machine that performs load balancing and subjected to load balancing. However, if the virtual machine that performs load balancing merely takes over an IP address, session information that is being communicated between the virtual machine that provides the work service and the client is lost, which makes it difficult to maintain the content of communication from before the start of load balancing.

### SUMMARY

According to one aspect, there is provided a load balancing function deploying method including: receiving, by a computer, a deployment instruction for a new virtual machine that controls communication between a first virtual machine, which has a function for communicating with at least one virtual machine, and a second virtual machine; creating, by the computer, a second driver corresponding to a first driver, which is provided in the first virtual machine and is used for communication with the second virtual machine, and a third driver, which is used for communication between the new virtual machine and the first virtual machine, in the new virtual machine; connecting, by the computer, the second driver and the third driver using a virtual bridge; and invalidating, by the computer, the first driver and validating the second driver after enabling the second driver to use a buffer region used by the first driver.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 depicts a load balancing function deploying apparatus 10 according to a first embodiment;

FIG. 2 depicts an example of an information processing system according to a second embodiment;

FIG. 3 depicts example hardware of a work server;

FIG. 4 depicts examples of virtual machines;

FIG. 5 depicts an example of communication by virtual machines;

FIG. 6 depicts an example connection of virtual machines;

FIG. 7 depicts an example of a rolling update;

FIG. 8 depicts a comparative example of SLB deployment;

FIG. 9 depicts a comparative example of connecting virtual machines after SLB deployment;

FIG. 10 depicts an example connection of virtual machines after SLB deployment;

FIG. 11 depicts example functions of a work server;

FIG. 12 depicts an example of a VM management table;

FIG. 13 depicts an example of a network management table;

FIG. 14 is a flowchart depicting an example of device migration;

FIG. 15 is a flowchart depicting one example of SLB deployment;

FIGS. 16A to 16C depict an example of updating of tables by an SLB deploying unit;

FIGS. 17A to 17C depict an example of updating of tables by an SLB deploying unit (continued);

FIG. 18 is a flowchart depicting an example of buffer switching;

FIGS. 19A and 19B depict an example of table updating by a buffer switching unit;

FIG. 20 depicts an example of load balancing after migration;

FIG. 21 depicts an example (first example) of SLB deployment;

FIG. 22 depicts an example (second example) of SLB deployment;

FIG. 23 is a flowchart depicting an example of SLB removal;

FIG. 24 depicts an example of SLB removal;

FIG. 25 depicts an example (first example) of an updating method of a virtual machine; and

FIG. 26 depicts an example (second example) of an updating method of a virtual machine.

### DESCRIPTION OF EMBODIMENTS

Several embodiments will be described below with reference to the accompanying drawings, wherein like reference numerals refer to like elements throughout.

### First Embodiment

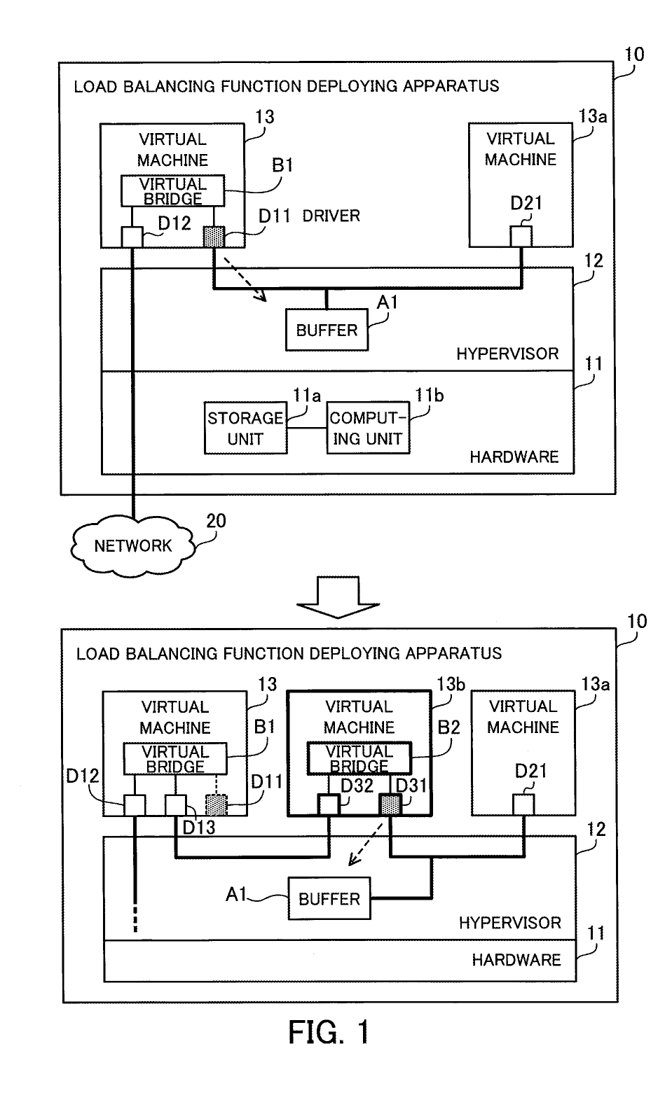

FIG. 1 depicts a load balancing function deploying apparatus 10 according to a first embodiment. The load balancing function deploying apparatus 10 is capable of running a plurality of virtual machines. The load balancing function deploying apparatus 10 is connected to a network 20. Although not illustrated, a client computer (or simply “client”) is connected to the network 20. The client makes use of services provided by virtual machines on the load balancing function deploying apparatus 10.

The load balancing function deploying apparatus 10 includes hardware 11, a hypervisor 12, and virtual machines 13 and 13a. The hardware 11 is a group of physical resources of the load balancing function deploying apparatus 10. The hardware 11 includes a storage unit 11a and a computing unit 11b.

The storage unit 11a is a volatile storage apparatus, such as RAM. The computing unit 11b may be a CPU, a DSP (Digital Signal Processor), an ASIC (Application Specific Integrated Circuit), an FPGA (Field Programmable Gate Array), or the like. The computing unit 11b may be a processor that executes a program. Here, the expression “processor” may include a group of a plurality of processors (a so-called “multiprocessor”). Aside from the storage unit 11a and the computing unit 11b, the hardware 11 may include a nonvolatile storage apparatus such as an HDD (Hard Disk Drive), a NIC (network interface card) (physical NIC) connected to the network 20, and the like.

The hypervisor 12 is software that runs the virtual machines 13 and 13a using the resources of the hardware 11. The virtual machines 13 and 13a are virtual computers that independently run OSs. The virtual machine 13 runs a host OS. The host OS manages the resources of the hardware 11 and performs management tasks such as starting and stopping an OS (also referred to as a “guest OS”) running on another virtual machine, such as the virtual machine 13a. The virtual machine 13 includes device drivers that control the hardware 11. Accesses to the hardware 11 by the guest OS running on the virtual machine 13a are performed via the host OS. That is, the host OS manages accesses to the hardware 11 by the guest OS. The host OS is also referred to as the “management OS”. The virtual machine 13 itself is also referred to as the “host OS”.

The virtual machine 13 has a function for communicating with one or more virtual machines. The virtual machine 13 has drivers D11 and D12 and a virtual bridge B1. The driver D11 operates in conjunction with a driver on the virtual machine 13a to realize a virtual NIC of the virtual machine 13a. The driver D11 is also referred to as a “backend driver”. The driver D12 is a device driver that controls a physical NIC. The virtual bridge B1 connects the drivers D11 and D12.

The virtual machine 13a has a driver D21. The driver D21 operates in conjunction with the driver D11 to perform data transfers between the virtual machines 13 and 13a. The driver D21 is also referred to as a “frontend driver”. The drivers D11 and D21 share a buffer region A1. The buffer region A1 is a storage region managed by the hypervisor 12. The buffer region A1 may be a storage region reserved in the storage unit 11a. As described above, with a connection configuration where a physical NIC and a virtual NIC are connected via the virtual bridge B1, it is possible for the virtual machine 13a to operate as if present on the same L2 (Layer 2) network as other physical machines or other virtual machines on the network 20.

The load balancing function deploying apparatus 10 provides services executed by the virtual machine 13a to a client connected to the network 20. The load balancing function deploying apparatus 10 is capable of additionally deploying a virtual machine 13b (or “new virtual machine”) that executes load balancing for a plurality of virtual machines (including the virtual machine 13a) that run guest OSs. As one example, such deployment may occur when the guest OS and the application that provides services at the virtual machine 13a are updated. This is because providing redundancy for the provision of services (i.e., deploying a virtual machine that provides the same services as the virtual machine 13a in addition to the virtual machines 13, 13a and 13b) makes it possible to reduce the time for which the provision of services stops due to an updating operation. The load balancing function deploying apparatus 10 deploys the virtual machine 13b as described below. The processing of the computing unit 11b described below may be implemented as a function of the hypervisor 12.

The computing unit 11b receives a deployment instruction for a new virtual machine that controls communication between the virtual machine 13 and the virtual machine 13a. The new virtual machine is in charge of a load balancing function for a plurality of virtual machines that include the virtual machine 13a.

The computing unit 11b creates, in the virtual machine 13b, a driver D31 (second driver) corresponding to the driver D11 (first driver) of the virtual machine 13 that is used for communication with the virtual machine 13a. The driver D31 is a backend driver for connecting to the driver D21. The computing unit 11b also creates, in the virtual machine 13b, a driver D32 (third driver) used for communication between the virtual machine 13b and the virtual machine 13. The driver D32 is a frontend driver. The computing unit 11b connects the drivers D31 and D32 using a virtual bridge B2. Note that “creating” a driver here refers for example to adding driver information to predetermined configuration information of the virtual machine in question and causing a virtual machine to execute a predetermined control service based on the configuration information so that the driver runs on the virtual machine.

The computing unit 11b changes the buffer region A1 used by the driver D11 to a buffer region of the driver D31. More specifically, the computing unit 11b sets an access destination address for the buffer region of the driver D31 at the address of the buffer region A1. That is, the driver D31 hereafter uses the buffer region A1. Here, as one example, by changing the destination of accesses by the driver D11 to an address designating an access prohibited region so as to trap data writes by the driver D11, the computing unit 11b can also write data subjected to writes by the driver D11 into the buffer region A1. By doing so, data being communicated by the driver D11 can continue to be written into the buffer region A1.

After this, the computing unit 11b invalidates the driver D11 and validates the driver D31. Here, “invalidating” the driver D11 refers for example to deleting information on the driver D11 from the predetermined configuration information of the virtual machine 13 and then running a control service of the virtual machine 13. Also, “validating” the driver D31 refers to enabling communication that uses the driver D31. More specifically, by invalidating the driver D11 and having the virtual machine 13 newly run the driver D13 that is the backend driver for the driver D32, the computing unit 11b starts communication using the drivers D13, D32, and D31. As a result, communication between the network 20 and the virtual machine 13a using the driver D31 becomes possible.

This process corresponds to the driver D11 (backend driver) that was running on the virtual machine 13 (host OS) being moved to the virtual machine 13b that executes load balancing. That is, the backend driver (the driver D31) that corresponds to the front end driver (the driver D21) of the virtual machine 13a is run at the virtual machine 13b.

Since the drivers D31 and D32 are connected by the virtual bridge B2, it is possible to use the same IP address as before the assignment of the virtual machine 13b as the IP address corresponding to the driver D21. It is possible to have the virtual machine 13b execute a load balancing function for virtual machines (virtual machines that execute guest OSs, including the virtual machine 13a) connected via the virtual machine 13b. As one example, another virtual machine that provides redundancy for the provision of services by the virtual machine 13a runs on the hypervisor 12. In this case, when relaying on the virtual bridge B2, the virtual machine 13b may perform load balancing by identifying a plurality of virtual machines including the virtual machine 13a based on predetermined identification information.

As information for identifying the respective virtual machines, it is possible to use MAC (Media Access Control) addresses held by each virtual machine. That is, the virtual machine 13b manages a plurality of virtual machines as the assignment destinations of packets using the MAC addresses of the respective virtual machines. For example, the virtual machine 13b assigns packets, whose transmission source is an IP address of a client that was communicating before deployment of the virtual machine 13b, to the virtual machine 13a, even after deployment of the virtual machine 13b. The virtual machine 13b may acquire the IP address of such client from the virtual machine 13a after deployment of the virtual machine 13b. Since data being communicated between the virtual machine 13a and the client is stored in the buffer region A1 and the IP address of the virtual machine 13a does not need to be changed, it is possible at the virtual machine 13a to continue using the session ID from before the deployment of the virtual machine 13b. Accordingly, it is possible to maintain the existing content of communication between the virtual machine 13a and a client even after deployment of the virtual machine 13b.

Here, as the method for newly deploying a virtual machine that executes load balancing, it would be conceivable for the virtual machine that executes load balancing to take over the IP address (hereinafter “IP address a”) of the virtual machine 13a. A new IP address (hereinafter “IP address b”) is then assigned to the virtual machine 13a. An IP address (hereinafter “IP address c”) is also assigned to the virtual machine (which is newly deployed) that provides the same services as the virtual machine 13a.

Here, the virtual machine that executes load balancing is connected to the virtual machines (including the virtual machine 13a) under the control of such virtual machine via the backend driver and virtual bridge of the virtual machine 13 (the host OS). By doing so, it is possible to receive packets from a client that designates the IP address a using the virtual machine for load balancing and to set the transmission destinations of such packets at the IP addresses b and c.

However, with a method where the IP address of the virtual machine 13a is taken over by the virtual machine that performs load balancing, although it is possible to access services by continuously using the IP address a at the client side, it is not possible to maintain the session information that existed before deployment of the load balancing function. This is because an access destination that designates the IP address a at the client side is changed to the virtual machine that performs load balancing and the IP address of the virtual machine 13a is changed to the IP address b. Also, in keeping with the change in the IP addresses, a restart of network services may occur at the virtual machine 13a in order to load settings for after the change (i.e., information that was held by network services before such change is reset). When this happens, the virtual machine 13a and the client reconstruct a communication session, which carries the risk of the work that was being performed by the user being lost, which would force the user to repeat the work. There is also the risk of relearning of a MAC address learning table or the like occurring at switches included on the network 20, which would produce a period where communication between the client and the virtual machine 13a is not possible. Accordingly, a method where the IP address of the virtual machine 13a is taken over by a virtual machine that performs load balancing is inappropriate as a method of dynamic deployment.

On the other hand, according to the load balancing function deploying apparatus 10, the virtual machine 13a continues to use the IP address a even after deployment of the virtual machine 13b. The virtual machine 13b assigns packets whose transmission source is the IP address of a client that was communicating with the virtual machine 13a from before deployment of the virtual machine 13b to the virtual machine 13a.

In particular, the driver D31 continues to access the buffer region A1. Also, until the driver D11 is invalidated, data writes by the driver D11 are performed for the buffer region A1 used by the driver D31. By doing so, loss of packets being communicated is avoided. Accordingly, even after deployment of the virtual machine 13b, it is possible to appropriately maintain the content of existing communication between the virtual machine 13a and the client and to reduce the influence on services provided to the user. In addition, since the address does not change at the virtual machine 13a, there is no need for switches included on the network 20 to relearn a MAC address learning table or the like for the virtual machine 13a.

As another example, to execute a rolling update, it would be conceivable to deploy a virtual machine in charge of the load balancing function in advance. A rolling update is where virtual machines are redundantly provided and the provision of services by one virtual machine is switched to another virtual machine to prevent an interruption to the provision of services when updating software. However, when the provision of a given service to a given user is performed using a single virtual machine 13a as with the load balancing function deploying apparatus 10 described above, a load balancing function is unnecessary and it is wasteful to deploy a load balancing function in advance.

On the other hand, according to the load balancing function deploying apparatus 10, it is possible to dynamically deploy the virtual machine 13b that performs load balancing. This means that it is not necessary to deploy the virtual machine 13b that performs load balancing until the load balancing function is actually used, which prevents resources from being wasted.

However, in recent years, services, such as IaaS, that loan out computer resources to users via a network have come into use. As one example, with IaaS, a virtual machine including software such as an OS or application and resources for running a virtual machine are provided to users. An IaaS provider needs to manage their system without affecting the services used by users. Tasks that can affect the usage of services by users include security patches for an OS and update patches for applications. This is because the OS or application may restart due to a program being reloaded.

According to the load balancing function deploying apparatus 10, it is possible to dynamically deploy the virtual machine 13b and execute a rolling update while maintaining communication between the client and the virtual machine 13. This means that the load balancing function deploying apparatus 10 is also effective when software of a virtual machine is updated by an IaaS provider or the like.

### Second Embodiment

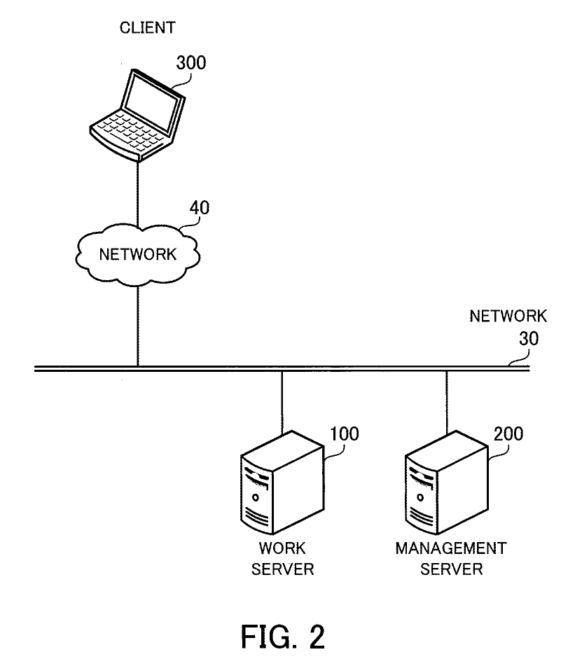

FIG. 2 depicts an example of an information processing system according to a second embodiment. The information processing system of the second embodiment includes a work server 100, a management server 200, and a client 300. The work server 100 and the management server 200 are connected to a network 30. The network 30 is a LAN (Local Area Network) installed in a data center. The data center is operated by an IaaS provider. The client 300 is connected to a network 40. The network 40 may be the Internet or a WAN (Wide Area Network), for example.

The work server 100 is a server computer equipped with hardware resources and software resources to be provided to IaaS users. The work server 100 is capable of executing a plurality of virtual machines. The virtual machines provide various services that support user jobs. The user is capable of operating the client 300 and using services provided by the work server 100. The work server 100 is one example of the load balancing function deploying apparatus 10 according to the first embodiment.

The management server 200 is a server computer that operates and manages the work server 100. As one example, a system manager operates the management server 200 to give instructions to the work server 100, such as starting and stopping the work server 100 and starting (deploying) and stopping new virtual machines.

The client 300 is a client computer used by the user. As one example, the client 300 functions as a Web browser. As one example, the work server 100 may function as a Web server that provides a GUI (Graphical User Interface) of a Web application that supports user jobs to a Web browser of the client 300. By operating a GUI on the Web browser of the client 300, the user is capable of using the functions of the Web application provided by the work server 100.

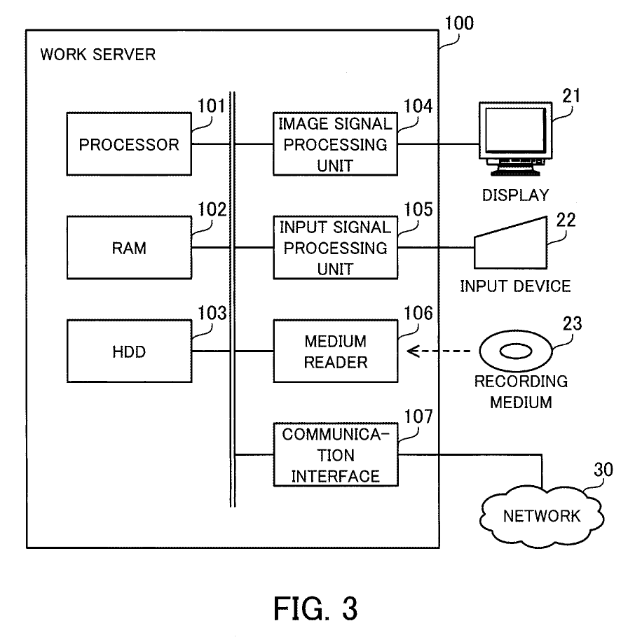

FIG. 3 depicts example hardware of a work server. The work server 100 includes a processor 101, a RAM 102, an HDD 103, an image signal processing unit 104, an input signal processing unit 105, a medium reader 106, and a communication interface 107. The respective units are connected to a bus of the work server 100. The management server 200 and the client 300 can be realized by the same units as the work server 100.

The processor 101 controls information processing by the work server 100. The processor 101 may be a multiprocessor. As examples, the processor 101 may be a CPU, a DSP, an ASIC, or an FPGA, or a combination of two or more of a CPU, a DSP, an ASIC, and an FPGA.

The RAM 102 is a main storage apparatus of the work server 100. The RAM 102 temporarily stores at least part of an OS program and an application program executed by the processor 101. The RAM 102 also stores various data used in processing by the processor 101.

The HDD 103 is an auxiliary storage apparatus of the work server 100. The HDD 103 magnetically reads and writes data from and onto internally housed magnetic disks. OS programs, application programs, and various data are stored in the HDD 103. The work server 100 may be equipped with another type of auxiliary storage apparatus, such as flash memory or an SSD (Solid State Drive), or may be equipped with a plurality of auxiliary storage apparatuses.

The image signal processing unit 104 outputs images to a display 21 connected to the work server 100 in accordance with instructions from the processor 101. As the display 21, it is possible to use a cathode ray tube (CRT) display, a liquid crystal display, or the like.

The input signal processing unit 105 acquires an input signal from an input device 22 connected to the work server 100 and outputs to the processor 101. As examples of the input device 22, it is possible to use a pointing device, such as a mouse or a touch panel, or a keyboard.

The medium reader 106 reads programs and data recorded on a recording medium 23. As examples of the recording medium 23, it is possible to use a magnetic disk such as a flexible disk or an HDD, an optical disc such as a compact disc (CD) or a digital versatile disc (DVD), or a magneto-optical (MO) disk. As another example, it is also possible to use a nonvolatile semiconductor memory, such as a flash memory card, as the recording medium 23. In accordance with an instruction from the processor 101, for example, the medium reader 106 stores a program or data read from the recording medium 23 in the RAM 102 or the HDD 103.

The communication interface 107 communicates with other apparatuses via the network 30. The communication interface 107 may be a wired communication interface or may be a wireless communication interface.

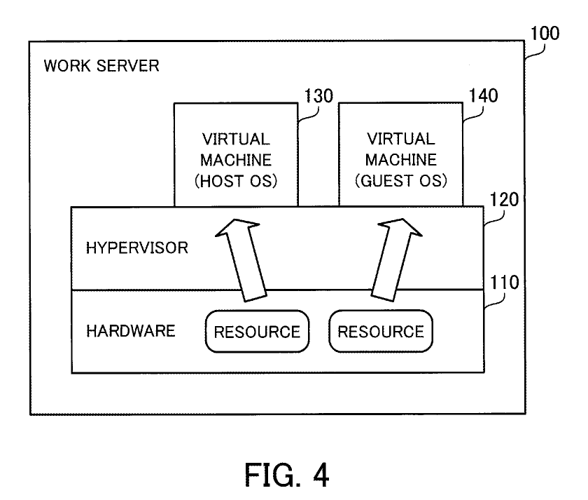

FIG. 4 depicts examples of virtual machines. The work server 100 includes hardware 110, a hypervisor 120, and virtual machines 130 and 140. The hardware 110 is a group of physical resources including the processor 101, the RAM 102, the HDD 103, the image signal processing unit 104, the input signal processing unit 105, the medium reader 106, and the communication interface 107.

The hypervisor 120 is control software that uses the resources of the hardware 110 to run virtual machines. The hypervisor 120 is also referred to as a “virtual machine monitor (VMM)”. The hypervisor 120 assigns the processing capacity of the processor 101 and the storage region of the RAM 102 as computing resources to the virtual machines 130 and 140. The hypervisor 120 performs arbitration for accesses to the hardware 110 from the virtual machines 130 and 140.

The hypervisor 120 is executed using resources of the processor 101 and the RAM 102 that are reserved separately to the resources assigned to the virtual machines 130 and 140. Alternatively, to run the hypervisor 120, the work server 100 may include a processor and RAM that are separate to the processor 101 and the RAM 102.

Units of processing capacity of the processor 101 that are assigned by the hypervisor 120 to the virtual machines 130 and 140 are referred to as “virtual processors” or “virtual CPUs”. As one example, when the processor 101 is a multicore processor, one core may be assigned as one virtual processor. As another example, it is possible to assign a time slice produced by time division of one cycle in a usable period of the processor 101 as one virtual processor. A storage region of the RAM 102 assigned by the hypervisor 120 to the virtual machines 130 and 140 is simply referred to as a “memory”. The amount of assigned memory is expressed by the size of the storage region using gigabytes (GB) or the like.

The virtual machines 130 and 140 are virtual machines that run on the work server 100. The virtual machine 130 is a virtual machine that executes the host OS. The host OS manages the assigning of resources in the hardware 110 to other virtual machines (for example, the virtual machine 140) that execute guest OSs and also manages device accesses by the other virtual machines. The virtual machine 130 is one example of the virtual machine 13 according to the first embodiment.

The virtual machine 140 is a virtual machine that executes a guest OS. The virtual machine 140 also executes an application that supports user jobs to provide work services to the user. Note that the expression “virtual machine” is also abbreviated to “VM”. The virtual machine 140 is one example of the virtual machine 13a according to the first embodiment.

At the work server 100, the plurality of guest OSs do not have their own physical I/O devices and input and output control of the respective guest OSs is virtualized by having inputs and outputs to and from the guest OSs requested to and executed by the host OS. As one example, when data is transferred from the host OS to a guest OS, the backend driver of the host OS passes the data over to the hypervisor 120. The hypervisor 120 then realizes a virtual data transfer by writing the data into a predetermined memory region used by the front end driver of the guest OS. Here, Xen (registered trademark) can be given as one example of the execution environment of this type of virtual machine. The virtual machine 130 is also referred to as “domain 0”. The virtual machine 140 is also referred to as “domain U”.

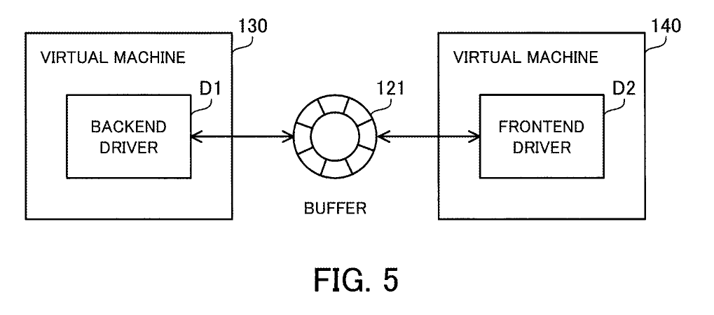

FIG. 5 depicts an example of communication by virtual machines. The virtual machine 130 directly controls the communication interface 107 (a physical NIC). The virtual machine 130 controls communication made via the communication interface 107 by another virtual machine executing a guest OS. As one example, consider a case where the virtual machine 140 is communicating via the virtual machine 130. The virtual machine 140 uses a para-virtualization driver. To accelerate the processing by the virtual machine 140, the PV driver is a driver that operates inside the kernel of the virtual machine 140 and has a function that directly calls the functions of the hypervisor 120. As one example, the virtual machine 140 uses the PV driver to access the HDD 103 and the communication interface 107.

In the PV driver, disk I/O (Input/Output) for the HDD 103 and network I/O are transferred to the virtual machine 130 via a device channel (also referred to as an “event channel”) and a buffer.

More specifically, a backend driver D1 of the virtual machine 130 that executes the host OS and a frontend driver D2 of the virtual machine 140 that executes a guest OS operate in conjunction. The backend driver D1 and the frontend driver D2 are in one-to-one correspondence.

The buffer 121 is a buffer region managed by the hypervisor 120 (such “buffer regions” are also referred to as “buffers”). The buffer 121 is a ring buffer that is shared by the backend driver D1 and the frontend driver D2. The buffer 121 is reserved as a storage region in the RAM 102, for example. The backend driver D1 and the frontend driver D2 transfer data via the buffer 121. More specifically, when either driver out of the backend driver D1 and the frontend driver D2 has written the value of an address or the like of the shared memory and issued a hypervisor call, the other driver can read the written address.

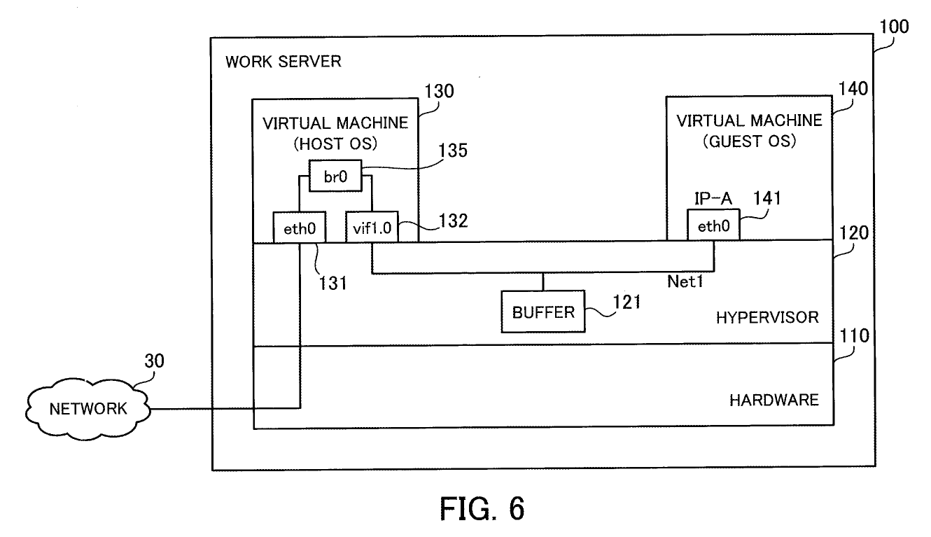

FIG. 6 depicts an example connection of the virtual machines. FIG. 6 illustrates an example where the virtual machines 130 and 140 run on the hypervisor 120. In the example in FIG. 5, the virtual machines 130 and 140 transfer data via the buffer 121.

The virtual machine 130 has a device driver 131, a backend driver 132, and a bridge 135. The device driver 131 is software that controls the communication interface 107. The communication interface 107 is associated with the identification information “eth0” at the virtual machine 130.

The backend driver 132 is software that is used for communication with the virtual machine 140. The backend driver 132 is associated with the identification information “vif1.0”.

The bridge 135 is a virtual bridge that connects the device driver 131 and the backend driver 132. The bridge 135 is associated with the identification information “br0”.

The virtual machine 140 has a frontend driver 141. The frontend driver 141 is software that functions as a virtual communication interface of the virtual machine 140. The frontend driver 141 is associated with the identification information “eth0” at the virtual machine 140. The IP address of the frontend driver 141 is “IP-A”.

The backend driver 132 and the frontend driver 141 share the buffer 121 depicted in FIG. 5. The backend driver 132 and the frontend driver 141 transfer data via the buffer 121. Since the backend driver 132 and the frontend driver 141 have a channel for communicating with each other, such drivers can be said to be “connected”. Here, the connection between the backend driver and the frontend driver is also referred to as a “net”. The hypervisor 120 manages the connection between the backend driver 132 that corresponds to “vif1.0” and the frontend driver 141 by associating the connection with the identification information “Net1” (also referred to as a “Net ID”). Here, the backend driver 132 and the frontend driver 141 can also be said to belong to a net identified as “Net1”.

It is important for an IaaS provider to provide users with the latest version of software, such as an OS or an application. In particular, if an update program has been distributed by a software vendor to fix a security hole, a bug, or the like, it is preferable for software in question to be rapidly updated using such update program. For this reason, an update job for software to be executed by the virtual machine 140 is produced at the work server 100. Here, it is important to avoid or minimize stoppages to the services provided to users by the virtual machine 140. One conceivable method for doing so is a rolling update.

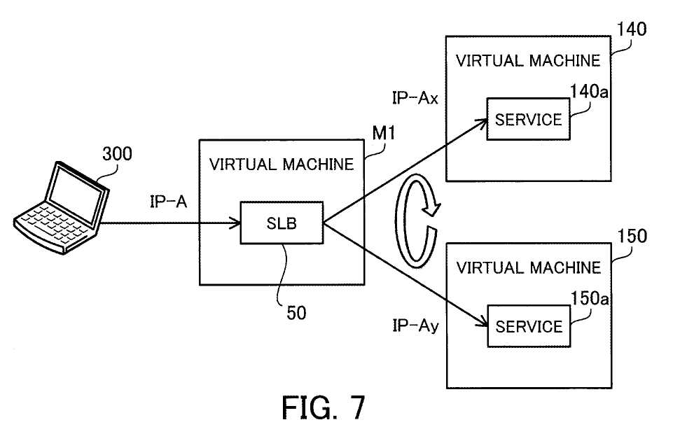

FIG. 7 depicts an example of a rolling update. As one example, it would be conceivable to deploy in advance a virtual machine M1 that performs load balancing at the work server 100 and to perform a rolling update when updating the software. The virtual machine M1 is a virtual machine that runs on the hypervisor 120. The virtual machine M1 includes an SLB (Server Load Balancer) 50. The SLB 50 is software that realizes a load balancing function.

The virtual machine 140 has a service 140a. The service 140a is software that provides predetermined services to the client 300. The virtual machine 150 is a virtual machine that runs on the hypervisor 120. The virtual machine 150 has a service 150a that provides the same functions as the service 140a. In the example in FIG. 7, the IP address of the virtual machine M1 is “IP-A”. The IP address of the virtual machine 140 is “IP-Ax”. The IP address of the virtual machine 150 is “IP-Ay”.

When using services of the virtual machine 140, the client 300 transmits a request that designates the destination IP address “IP-A”. On receiving the request, the SLB 50 decides an assignment destination out of the virtual machines 140 and 150 in accordance with the loads of the virtual machines 140 and 150 or according to a predetermined method, such as round robin. As one example, when the virtual machine 140 is decided as the assignment destination, the SLB 50 changes the destination IP address to “IP-Ax” and transfers to the virtual machine 140. On receiving a response whose transmitter IP address is “IP-Ax” from the virtual machine 140, the SLB 50 changes the transmitter IP address to “IP-A” and transfers to the virtual machine 140.

When the virtual machines that provide services are redundantly provided, as with the virtual machines 140 and 150, it is possible to use a rolling update when updating the software of one of the virtual machines. More specifically, by updating the virtual machines one at a time in order, it is possible to update the software without stopping the provision of services to users.

On the other hand, when, as depicted in FIG. 4, the virtual machines M1 and 150 are not present, it would be conceivable to perform a rolling update by newly deploying the virtual machines M1 and 150.

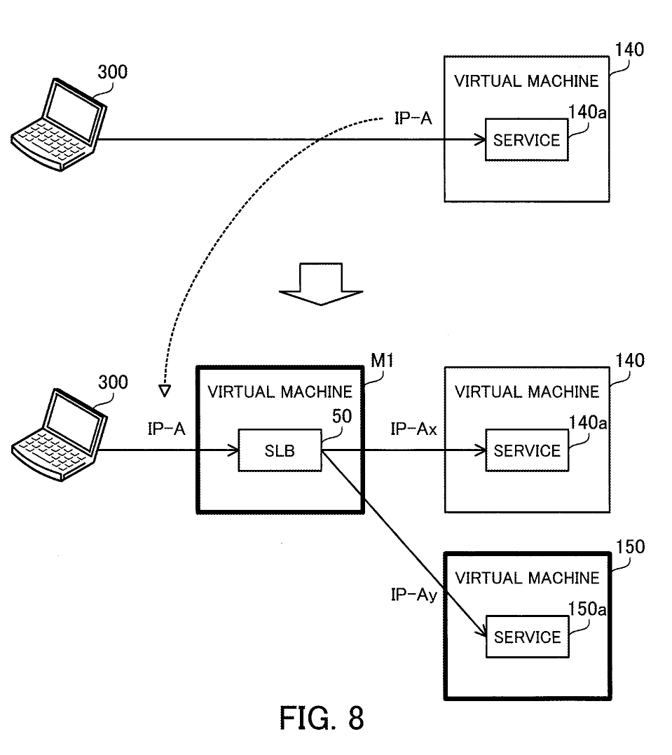

FIG. 8 depicts a comparative example of SLB deployment. Before deployment of the virtual machine M1, the IP address of the virtual machine 140 is “IP-A”. When the virtual machines M1 and 150 are newly deployed, the hypervisor 120 newly sets IP addresses for the virtual machines M1 and 150.

Here, by giving the virtual machine M1 the IP address used by the client 300 to access the service 140a, the configuration changes to a load balancing configuration performed via the virtual machine M1. When such IP address is taken out of use, requests from the client 300 can no longer reach the services 140a and 150a. The hypervisor 120 also sets the IP address of the virtual machine 140 at “IP-Ax” and the IP address of the virtual machine 150 at “IP-Ay”.

By doing so, it is possible to produce the same load balancing configuration as FIG. 7 and to execute a rolling update. Note that in this situation, since one virtual machine is sufficient to provide services, it is possible to use a method that starts the virtual machine 150 in a state where updated software has been installed in the virtual machine 150 and then removes the virtual machine 140.

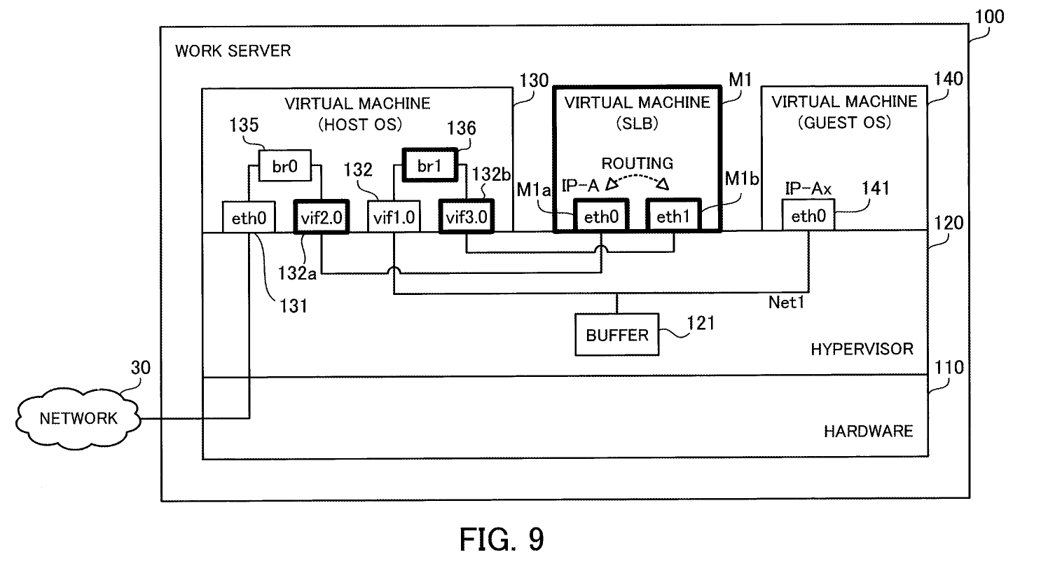

FIG. 9 depicts a comparative example of connecting virtual machines after SLB deployment. FIG. 9 depicts an example connection between the virtual machines 130, 140 and M1 when the virtual machine M1 has been deployed as depicted in FIG. 8. Note that the virtual machine 150 has been omitted from the drawing.

The virtual machine 130 has the device driver 131, backend drivers 132, 132a, and 132b, and bridges 135 and 136. The backend drivers 132a and 132b are software used to communicate with the virtual machine M1. The backend driver 132a is associated with the identification information “vif2.0” and the backend driver 132b is associated with the identification information “vif3.0”.

The bridge 135 connects the device driver 131 and the backend driver 132a. The bridge 136 connects the backend drivers 132 and 132b. The bridge 136 is associated with the identification information “br1”.

The virtual machine M1 has the frontend drivers M1a and M1b. The frontend drivers M1a and M1b are software that functions as virtual interfaces for the virtual machine M1. The IP address of the frontend driver M1a is “IP-A” (which corresponds to the IP address “IP-A” in FIG. 8). The frontend driver M1a is connected to the backend driver 132a. The frontend driver M1b is connected to the backend driver 132b. Since the IP address “IP-A” is used by the virtual machine M1, the IP address of the frontend driver 141 of the virtual machine 140 is changed to “IP-Ax” (which corresponds to the IP address “IP-Ax” in FIG. 8).

Note that although not illustrated, in the example in FIG. 9, the virtual machine 150 is connected to the virtual machine 130 via the virtual machine M1 in the same way as the virtual machine 140. That is, two backend drivers that respectively connect to the virtual machines M1 and 150 and a bridge that connects the backend drivers are added to the virtual machine 130. Another front end driver that connects to the backend driver of the virtual machine 130 is also added to the virtual machine M1.

As depicted in FIG. 8, by merely deploying the virtual machine M1 so as to take over the IP address of the virtual machine 140, the virtual machines become connected as described above. However, when the virtual machines M1 and 150 are newly deployed as in FIGS. 8 and 9 and the setting of the IP address of the virtual machine 140 is changed, it becomes no longer possible to use the session information of the communication between the client 300 and the virtual machine 140 from before the change in the load balancing configuration. This means that a session is newly established between the client 300 and the virtual machine 140 in keeping with the change in the load balancing configuration. This carries the risk of forcing the user to repeat a job that was being performed, and is unfavorable in terms of the quality of the provided IaaS services.

In addition, when an address is changed at the virtual machine 140, relearning of the MAC address learning table may occur at switches included in the networks 30 and 40. In this situation, there is the further risk of a comparatively long break (which increases in keeping with the length of the timeout for the session established between the client 300 and the virtual machine 140) in communication between the client 300 and the virtual machine 140.

Note that instead of deploying the virtual machine M1, it would be conceivably possible to perform load balancing by having a DNS (Domain Name Server) (not illustrated in FIG. 2) connected to the network 30 or the network 40 execute round robin DNS. However, with round robin DNS, load balancing cannot be performed when access is made by the client 300 directly designating an IP address. Also, since the load is evenly distributed between the virtual machines 140 and 150, it is difficult to perform flow control during an update, such as assigning traffic to only one virtual machine.

For this reason, the work server 100 deploys a virtual machine that runs the SLB 50 as described below and does not change the address of the virtual machine 140. First, an example connection of the virtual machines will be described.

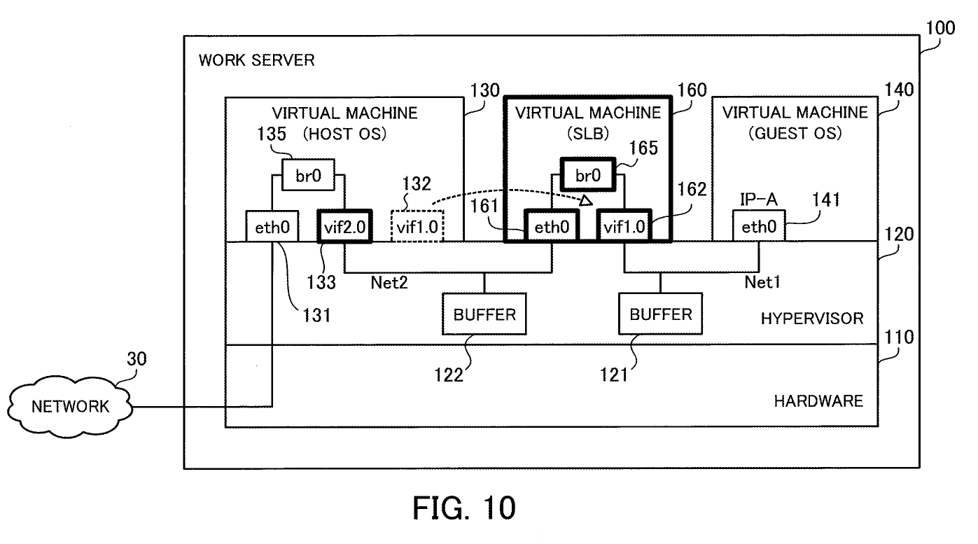

FIG. 10 depicts an example connection of the virtual machines after SLB deployment. In this second embodiment, the hypervisor 120 deploys a virtual machine 160 in place of the virtual machine M1. The virtual machine 160 is connected to the virtual machines 130 and 140 differently to the virtual machine M1. The virtual machine 160 performs load balancing for the virtual machines 140 and 150. Although the virtual machine 150 is not illustrated in FIG. 10, an example connection that includes the virtual machine 150 is described later.

The virtual machine 130 has the device driver 131, a backend driver 133, and the bridge 135. The backend driver 133 is software used for communication with the virtual machine 160. The backend driver 133 is associated with the identification information “vif2.0”. In FIG. 10, the backend driver 132 is depicted as a block surrounded by a broken line. This is because the functions of the backend driver 132 (for example, a function for communicating with the virtual machine 140) are moved (migrated) to the virtual machine 160. The backend driver 132 is invalidated at the virtual machine 130. Here, the bridge 135 connects the device driver 131 and the backend driver 133.

The virtual machine 160 includes a frontend driver 161, a backend driver 162, and a bridge 165. The frontend driver 161 is software that functions as a virtual communication interface of the virtual machine 160. The frontend driver 161 is associated with the identification information “eth0” at the virtual machine 160. Note that a buffer 122 is provided for the backend driver 133 and the frontend driver 161. The hypervisor 120 manages the connection between the backend driver 133 corresponding to “vif2.0” and the frontend driver 161 by associating the connection with the Net ID “Net2”.

The backend driver 162 is software used for communication with the virtual machine 140. The backend driver 162 is a driver corresponding to the backend driver 132. The backend driver 162 is associated with the identification information “vif1.0”.

In this configuration, the frontend driver 141 of the virtual machine 140 is connected to the backend driver 162. The buffer 121 is hereafter used for communication between the frontend driver 141 and the backend driver 162. The hypervisor 120 manages the connection between the backend driver 162 corresponding to “vif1.0” and the frontend driver 161 by associating the connection with the Net ID “Net1”.

For example, the hypervisor 120 adds and deletes information on the frontend driver, the backend driver, and the bridge of each virtual machine to or from predetermined config information or the like (for example, when Xen is used, an xend-config file, a domain definition file, or the like). The hypervisor 120 then uses a virtual machine to run a predetermined control service (for example, xend) based on the configuration information to add or delete various drivers and bridges to the respective virtual machines.

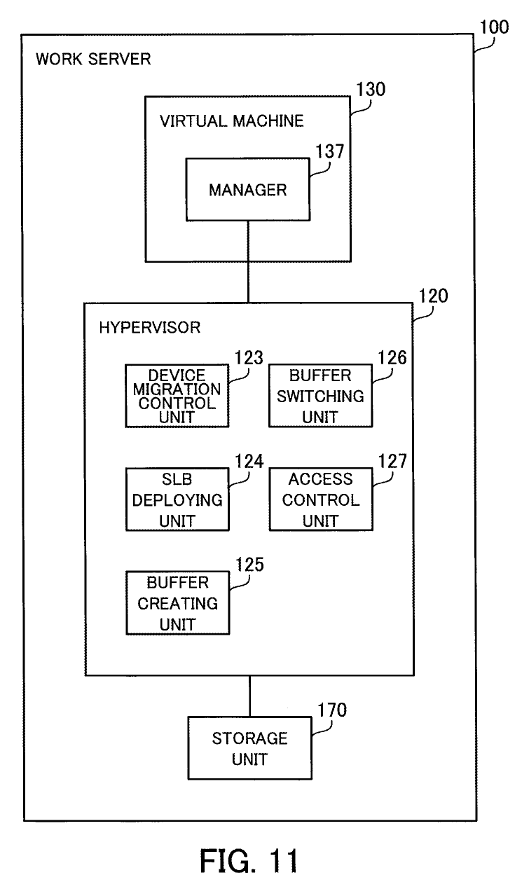

FIG. 11 depicts example functions of a work server. The hypervisor 120 includes a device migration control unit 123, an SLB deploying unit 124, a buffer creating unit 125, a buffer switching unit 126, and an access control unit 127. The device migration control unit 123, the SLB deploying unit 124, the buffer creating unit 125, the buffer switching unit 126, and the access control unit 127 are realized by the processor 101 executing a program or programs stored in the RAM 102.

When newly deploying a virtual machine for SLB purposes, the device migration control unit 123 controls migration of the backend driver from a given virtual machine to another virtual machine. As one example, as described with reference to FIG. 10, the device migration control unit 123 runs the backend driver 162 at the virtual machine 160 instead of running the backend driver 132 at the virtual machine 130.

The SLB deploying unit 124 deploys the virtual machine 160 that has a load balancing function. The SLB deploying unit 124 sets connections between the frontend driver 161, the backend driver 162, and the bridge 165 of the virtual machine 160.

The buffer creating unit 125 reserves a buffer (i.e., “creates” a buffer) that is shared by a backend driver and a front end driver in the RAM 102. The buffer creating unit 125 provides a buffer for each pair of a back end driver and a front end driver.

The buffer switching unit 126 switches a destination address for data writes by the backend driver. As one example, the buffer switching unit 126 switches the destination of a data write by the backend driver 132 to the address of a prohibited region in the RAM 102. By doing so, it is possible to trap writes by the backend driver 132 to make it possible to change the write destination to another address (i.e., the address of another buffer).

The access control unit 127 controls access from the respective drivers to the buffers. The access control unit 127 controls the permitting and prohibiting of write and read access from the respective drivers to the respective buffers.

The virtual machine 130 has a manager 137. The manager 137 is realized by a virtual processor assigned to the virtual machine 130 executing a program in a memory assigned to the virtual machine 130.

The manager 137 is management software that issues operation instructions to the work server 100. The manager 137 notifies the hypervisor 120 of instructions for new deployment of virtual machines (including an SLB virtual machine), instructions for removing a virtual machine, and the like. The manager 137 is also capable of changing the load balancing settings of the SLB in the virtual machine 160. Note that the management server 200 may realize the functions of the manager 137.

A storage unit 170 stores information used in processing by the hypervisor 120. More specifically, the storage unit 170 stores a VM management table for managing the backend drivers and frontend drivers of the respective virtual machines. The storage unit 170 also stores a network management table for managing the buffers shared by the backend drivers and frontend drivers.

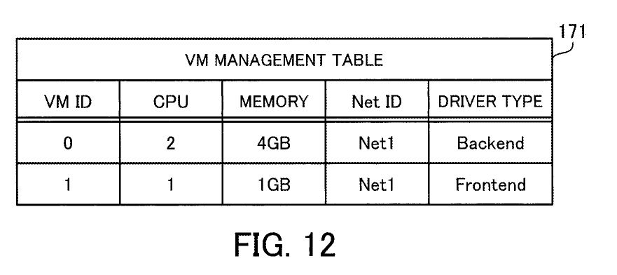

FIG. 12 depicts an example of a VM management table. The VM management table 171 is stored in the storage unit 170. The VM management table 171 includes VM ID, CPU, Memory, Net ID, and Driver Type columns.

The IDs of virtual machines are registered in the VM ID column. The number of virtual processors assigned to each virtual machine is registered in the CPU column. The size of the memory assigned to each virtual machine is registered in the Memory column. A Net ID is registered in the Net ID column. Some entries in the VM management table 171 have no setting (indicated by a hyphen) in the Net ID column. A driver type is registered in the Driver Type column. The driver type is information indicating a frontend driver or a backend driver. Some entries in the VM management table 171 have no setting (indicated by “None”) of driver type.

Here, an example is depicted where information on the respective drivers of the virtual machine 130 and the virtual machine 140 illustrated in FIG. 6 has been registered in the VM management table 171. As one example, an entry where the VM ID is “0”, the CPU is “2”, the Memory is “4 GB”, the Net ID is “Net1”, and the driver type is “Back end” is registered in the VM management table 171. The VM ID “0” designates the virtual machine 130. That is, the entry described above is the entry for the virtual machine 130 and indicates that the virtual machine 130 has been assigned two virtual processors and 4 GB of memory. This entry also indicates that the virtual machine 130 has one backend driver 132 and that the backend driver 132 belongs to a network identified by the Net ID “Net1”.

An entry where the VM ID is “1”, the CPU is “1”, the Memory is “1 GB”, the Net ID is “Net1”, and the driver type is “Frontend” is also registered in the VM management table 171. The VM ID “1” designates the virtual machine 140. That is, the entry described above is the entry for the virtual machine 140 and indicates that the virtual machine 140 has been assigned one virtual processor and 1 GB of memory. This entry also indicates that the virtual machine 140 has one frontend driver 141 and that the frontend driver 141 belongs to a network identified by the Net ID “Net1”.

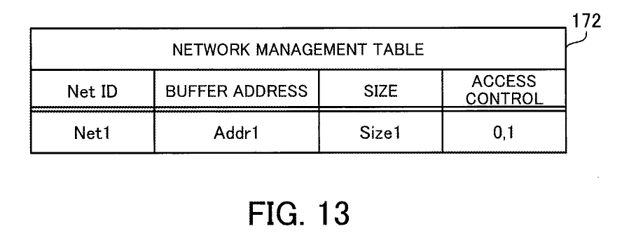

FIG. 13 depicts an example of a network management table. The network management table 172 is stored in the storage unit 170. The network management table 172 includes Net ID, buffer address, size, and access control columns.

A Net ID is registered in the Net ID column. The address used when the hypervisor 120 accesses the buffer in question based on a request from each virtual machine is registered in the Buffer Address column (so that access to a buffer by each virtual machine is performed via the hypervisor 120). The size of the buffer is registered in the Size column. Information on access control for the buffer in question is registered in the Access Control column. More specifically, VM IDs of virtual machines permitted to access the buffer in question are registered in the Access Control column. A virtual machine corresponding to a VM ID that is not registered in the Access Control column is not permitted to access the buffer in question.

As one example, an entry with the Net ID “Net 1”, the buffer address “Addr1”, the size “Size1”, and the access control “0,1” is registered in the network management table 172. This indicates that the address of the buffer 121 corresponding to the net identified by the net ID “Net1” is “Addr1” and the size is “Size1”. Access to the buffer 121 from the virtual machine 130 with the VM ID “0” and the virtual machine 140 with the VM ID “1” is permitted and access to the buffer 121 from other virtual machines is not permitted.

Next, the processing procedure of the work server 100 will be described.

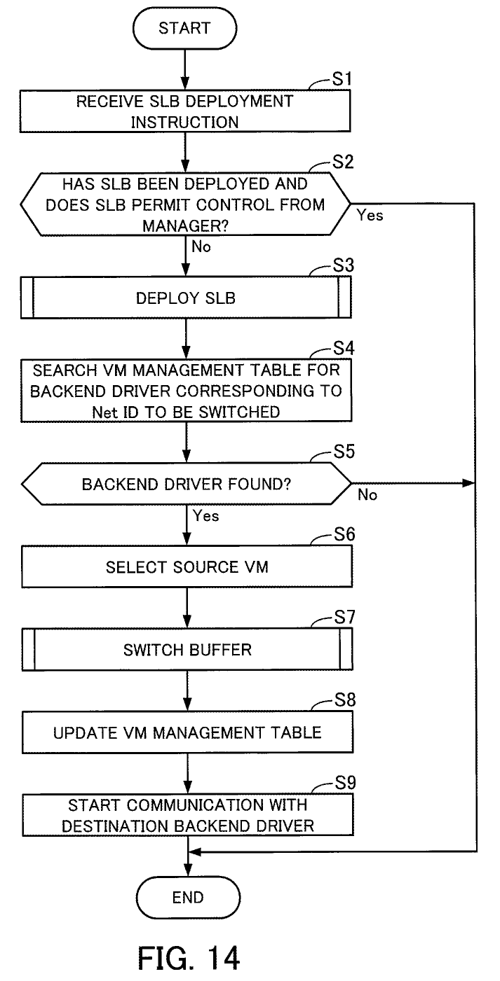

FIG. 14 is a flowchart depicting an example of device migration. The processing depicted in FIG. 14 is described below in order of the step numbers.

(S1) The device migration control unit 123 receives an SLB deployment instruction from the manager 137. As one example, the system manager may operate an input device connected to the management server 200 or the work server 100 to input an SLB deployment instruction into the work server 100. On receiving the SLB deployment instruction, the manager 137 notifies the device migration control unit 123 of the SLB deployment instruction. The SLB deployment instruction includes information that designates the virtual machine to be subjected to load balancing (for example, the virtual machine 140).

(S2) The device migration control unit 123 determines whether an SLB has been deployed at the work server 100 and whether the SLB permits control from the manager 137. When an SLB has been deployed and the SLB permits control from the manager 137, the processing ends. When an SLB has not been deployed or an SLB has been deployed but control from the manager 137 is not permitted, the processing proceeds to step S3. Here, the reason that the processing ends when the result of step S2 is “Yes” is that it is possible to perform a rolling update by operating the load balancing settings of the existing SLB from the manager 137, for example. On the other hand, when the result of step S2 is “No”, the virtual machine 160 for SLB purposes is newly deployed.

(S3) The SLB deploying unit 124 executes deployment of an SLB (the virtual machine 160). In accordance with step S3, the VM management table 171 and the network management table 172 are updated. This is described in detail later.

(S4) The device migration control unit 123 searches the updated network management table 172 for backend drivers that correspond to a Net ID to be switched.

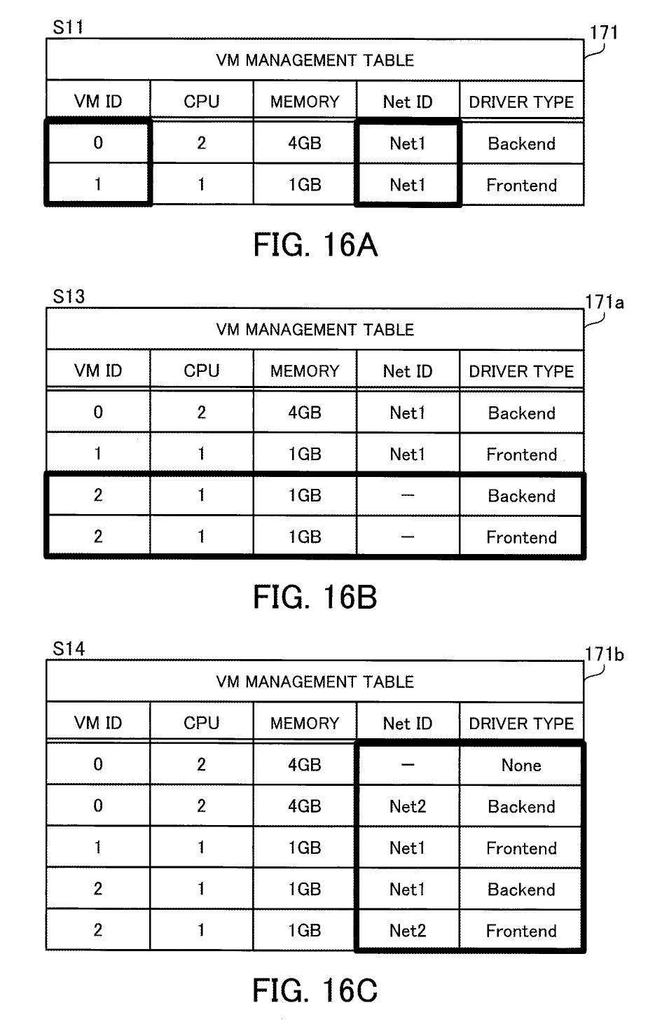

(S5) The device migration control unit 123 determines whether any backend drivers could be found. When a backend driver could be found, the processing proceeds to step S6. When no backend driver could be found, the processing ends (since this is an error, the device migration control unit 123 may execute predetermined error processing). As one example, when the Net ID subject to switching is “Net1”, the connection between the virtual machines 140 and 160 is registered in association with the Net ID “Net1” in the updated VM management table (as illustrated in FIGS. 16A to 16C). Accordingly, the backend driver found here for the Net ID “Net1” is the backend driver 162.

(S6) The device migration control unit 123 selects the source virtual machine of the backend driver based on the updated VM management table. As one example, the source virtual machine of the backend driver 162 is the virtual machine 130.

(S7) The buffer switching unit 126 switches the buffer that is the access destination for each virtual machine. This is described in detail later in this specification.

(S8) The device migration control unit 123 updates the updated VM management table to produce the latest state. As one example, the device migration control unit 123 performs operations such as deleting unnecessary entries.

(S9) The device migration control unit 123 starts communication by the destination backend driver. More specifically, when migrating the backend driver 132 to the backend driver 162, the device migration control unit 123 takes down the backend driver 132 and launches the backend driver 133. Alternatively, the device migration control unit 123 has the backend driver 132 stop operating and has the backend driver 133 start operating. By doing so, the backend driver 132 is invalidated. Communication that uses the backend drivers 133 and 162 and the frontend drivers 161 and 141 is also validated.

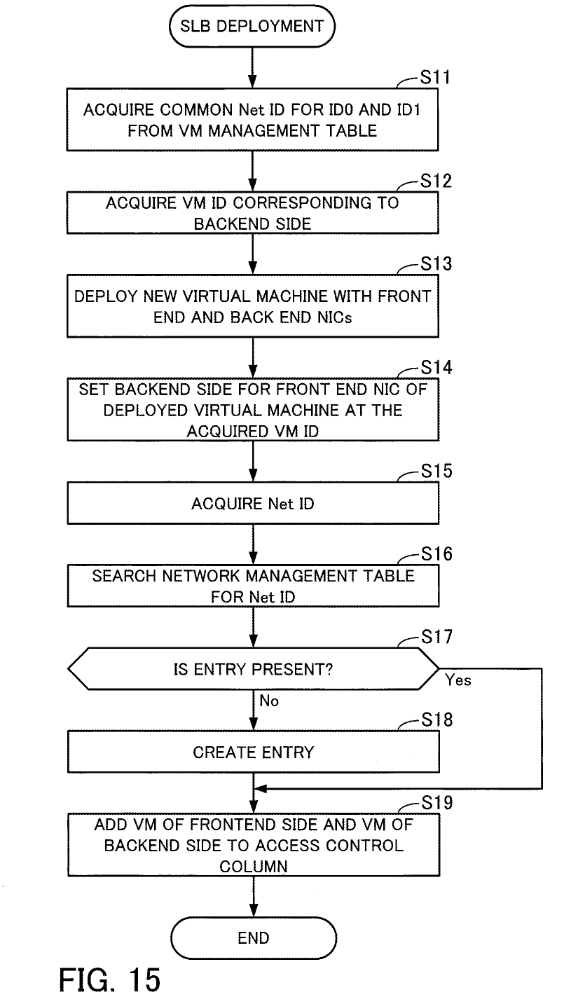

FIG. 15 is a flowchart depicting one example of SLB deployment. The processing depicted in FIG. 15 is described below in order of the step numbers. The following procedure corresponds to step S3 in FIG. 14. Note that it is assumed that the VM ID “1” (virtual machine 140) has been designated as the VM ID of the virtual machine to be subjected to load balancing. Since the frontend driver 141 of the virtual machine 140 is connected to the backend driver 132 of the virtual machine 130, the SLB deploying unit 124 changes the connection between the virtual machines 130 and 140 in keeping with the SLB deployment.

(S11) The SLB deploying unit 124 acquires, from the VM management table 171, a Net ID that is common to the VM ID “0” of the virtual machine 130 that executes the host OS and the VM ID “1” of the virtual machine 140 designated by the SLB deployment request. In the present example VM management table 171, such Net ID is “Net1”.

(S12) The SLB deploying unit 124 acquires, from the VM management table 171, a VM ID corresponding to the backend side (the backend driver side) for the acquired Net ID. As one example, when the Net ID is “Net1”, the VM ID corresponding to the back end side is “1” (the virtual machine 130).

(S13) The SLB deploying unit 124 deploys a new virtual machine (the virtual machine 160) that has two NICs, i.e., a frontend NIC and a backend NIC. Out of the two NICs, the front end corresponds to the frontend driver 161. The backend corresponds to the backend driver 162. The SLB deploying unit 124 updates the VM management table 171 in accordance with the deployment result.

(S14) In the updated VM management table, the SLB deploying unit 124 sets the backend side (the backend driver 133) for to the frontend NIC (the frontend driver 161) of the deployed virtual machine 160 at the VM ID “1” acquired in the step S12. That is, for the virtual machine 130, the SLB deploying unit 124 registers a new entry relating to the backend driver 133 in the VM management table. The SLB deploying unit 124 also registers the Net ID belonging to each driver in the VM management table.

(S15) The SLB deploying unit 124 acquires the Net ID of the net to which the backend driver 133 and the frontend driver 161 belongs from a virtual infrastructure (another process that runs on the hypervisor 120 and manages the connections between drivers). Note that the Net ID may be newly assigned by the SLB deploying unit 124. As one example, the SLB deploying unit 124 acquires the Net ID “Net2”.

(S16) The SLB deploying unit 124 searches the network management table 172 for the acquired Net ID. As one example, the SLB deploying unit 124 searches the network management table 172 for entries with the Net ID “Net2”.

(S17) The SLB deploying unit 124 determines whether an entry with the Net ID in question is present in the network management table 172. When an entry is present, the processing proceeds to step S19. When no entry is present, the processing proceeds to step S18.

(S18) The SLB deploying unit 124 creates an entry for the Net ID determined to not be present in step S17 in the network management table 172. As one example, the SLB deploying unit 124 creates an entry for the Net ID “Net2”. The buffer creating unit 125 newly creates a buffer corresponding to the created entry. The buffer creating unit 125 provides the address and size of the buffer to the SLB deploying unit 124.

(S19) The SLB deploying unit 124 adds the VM ID (for example, “1”) of the front end side and the VM ID (for example, “2”) of the back end side to the Access Control column in the network management table 172 for the Net ID acquired in step S15.

FIGS. 16A to 16C depict an example of updating of tables by the SLB deploying unit.

These drawings depict an example where a table is referred to or updated in steps S11, S13, and S14 of FIG. 15. FIG. 16A depicts the VM management table 171 in step S11, FIG. 16B depicts the VM management table 171a in step S13, and FIG. 16C depicts the VM management table 171b in step S14.

In step S11, the SLB deploying unit 124 refers to the VM management table 171. For example, the Net ID that is common to the VM IDs “0” and “1” is “Net1”. Out of the VM IDs “0” and “1” corresponding to “Net1”, the back end side is the VM ID “0” (step S12).

In step S13, the SLB deploying unit 124 updates the VM management table 171 to the VM management table 171a. More specifically, an entry where the VM ID “2” of the virtual machine 160 that has been newly deployed, the CPU is “1”, the memory is “1 GB”, the Net ID is “-” (no setting), and the driver type is “Backend” is registered. In the same way, an entry for the driver type “Frontend” is registered (the setting of the other columns is the same as the “Backend” entry).

In step S14, the SLB deploying unit 124 updates the VM management table 171a to the VM management table 171b. More specifically, for the entry of the backend driver 132 (which includes VM ID “0”, the Net ID “Net1” and the driver type “Backend”), no setting “-” is made for the Net ID and the driver type is set at “None”. Also, an entry of the backend driver 133 that is connected to the frontend driver 161 of the virtual machine 160 is registered so as to be associated with the VM ID “2” of the virtual machine 130. More specifically, this entry has the VM ID “0”, the Net ID “2” and the driver type “Backend”.

In addition, the SLB deploying unit 124 sets the Net ID “Net1” in the entry (with the VM ID “2”, the Net ID “-”, and the driver type “Backend”) of the backend driver 162 of the virtual machine 160. The SLB deploying unit 124 sets the Net ID “Nett” in the entry (with the VM ID “2”, the Net ID “-”, and the driver type “Frontend”) of the frontend driver 161 of the virtual machine 160.

Note that the search in step S4 of FIG. 14 is executed by referring to the VM management table 171b (a search is performed for the backend driver 162 for the Net ID “1” to be switched).

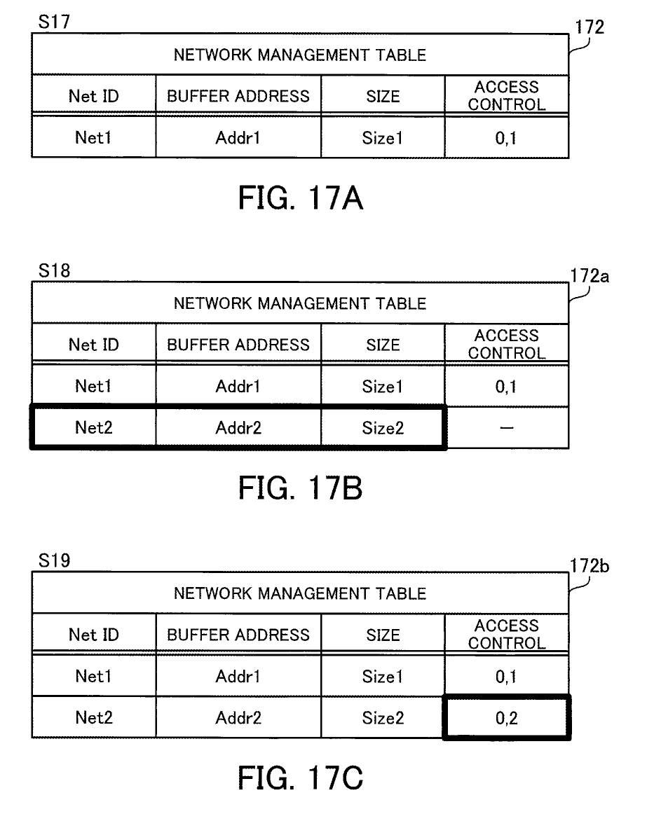

FIGS. 17A to 17C depict an example of updating of tables by the SLB deploying unit (continued). These drawings depict an example where a table is referred to or updated in steps S17, S18, and S19 of FIG. 15. FIG. 17A depicts the network management table 172 in step S17, FIG. 17B depicts the network management table 172a in step S18, and FIG. 17C depicts the network management table 172b in step S19.

In step S17, the SLB deploying unit 124 makes a determination based on the network management table 172. As an example scenario, the SLB deploying unit 124 refers to the network management table 172 and searches for the Net ID “Net2” but no entry for the Net ID “Net2” is present in the network management table 172.

In step S18, the SLB deploying unit 124 updates the network management table 172 to the network management table 172a. More specifically, the SLB deploying unit 124 adds an entry with the Net ID “Net 2” determined to not be present in step S17, the buffer address “Addr2”, and the size “Size2” to the network management table 172. At this stage, there is no setting (i.e., “-”) in the Address Control column. At this time, the SLB deploying unit 124 acquires information relating to the address and size of a buffer from the buffer creating unit 125.

In step S19, the SLB deploying unit 124 sets the VM ID “0” of the front end side and the VM ID “2” of the back end side in the Access Control column of the entry for the Net ID “Net2” in the network management table 172b.

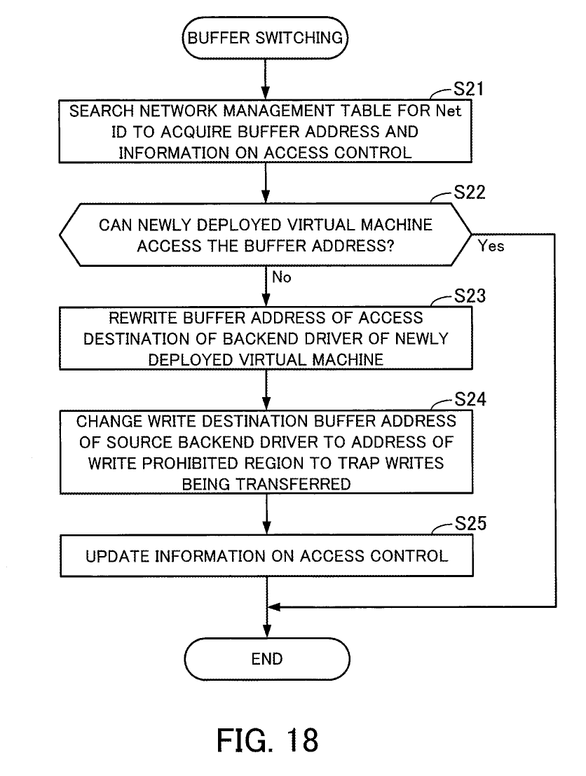

FIG. 18 is a flowchart depicting an example of buffer switching. The processing depicted in FIG. 18 is described below in order of the step numbers. The procedure described below corresponds to step S7 in FIG. 14.

(S21) The buffer switching unit 126 searches the network management table 172b for the switched Net ID (for example, “Net1”) to acquire a buffer address and information on access control.

(S22) The buffer switching unit 126 determines, based on the acquired access control information, whether the newly deployed virtual machine 160 can access the buffer address acquired in step S21. When access is possible, the processing ends. When access is not possible, the processing proceeds to step S23.

(S23) The buffer switching unit 126 rewrites the buffer address of the access destination of the backend driver 162 of the newly deployed virtual machine 160. More specifically, by manipulating information held by the backend driver 162, a pointer set at a default in the backend driver 162 is rewritten to the address (“Addr1”) of the buffer 121.

(S24) By changing the buffer address that is the access destination of the source backend driver 132 to the address of a write prohibited region, the buffer switching unit 126 traps writes that are being transferred. More specifically, the buffer switching unit 126 manipulates the information held by the backend driver 132 and changes a pointer (designating “Addr1”) in the backend driver 132 to an address for which writes by the backend driver 132 are prohibited. By doing so, it is possible for example to cause a hardware interrupt during a write to a prohibited region by the backend driver 132. Accordingly, with this interrupt, the buffer switching unit 126 is capable of trapping a data write by the backend driver 132. Here, the issuing of write by the backend driver 132 means that there is data that is being transferred. Accordingly, by writing the trapped data into the buffer 121, the buffer switching unit 126 is capable of storing data that is presently being transferred in the buffer 121.

(S25) The buffer switching unit 126 updates the access control information in the network management table 172b. More specifically, the buffer switching unit 126 makes settings so that access to the switched Net ID “Net1” is permitted by the virtual machines 140 and 160 and access is not possible by the virtual machine 130. However, as described for step S24, when a data write to the prohibited region by the backend driver 132 is trapped, a write to the buffer 121 of data to be written is permitted (such write is executed by the buffer switching unit 126 that is one function of the hypervisor 120).

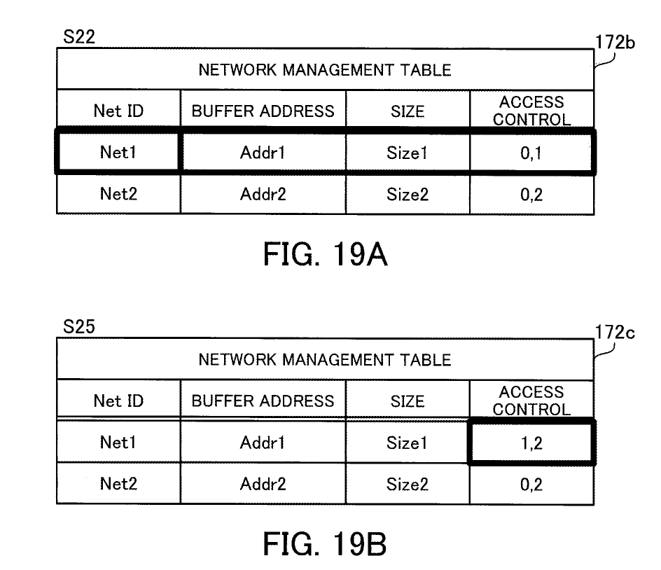

FIGS. 19A and 19B depict an example where a table is referred to or updated by the buffer switching unit. These drawings depict examples where a table is referred to and updated in steps S22 and S25 of FIG. 18. FIG. 19A depicts the network management table 172b in step S22. FIG. 19B depicts the network management table 172c in step S25.

In step S22, the buffer switching unit 126 makes a determination based on the network management table 172b. As an example scenario, the buffer switching unit 126 acquires the buffer address “Addr1” and the access control “0,1” for the Net ID “Net1”.

In step S25, the buffer switching unit 126 updates the network management table 172b to the network management table 172c. More specifically, the buffer switching unit 126 sets the access control column in the Net ID “Net1” entry at “1,2”. The access control unit 127 performs access control for each buffer based on the access control column of the network management table 172c.

By doing so, the work server 100 executes migration of the backend driver 132 to the backend driver 162.

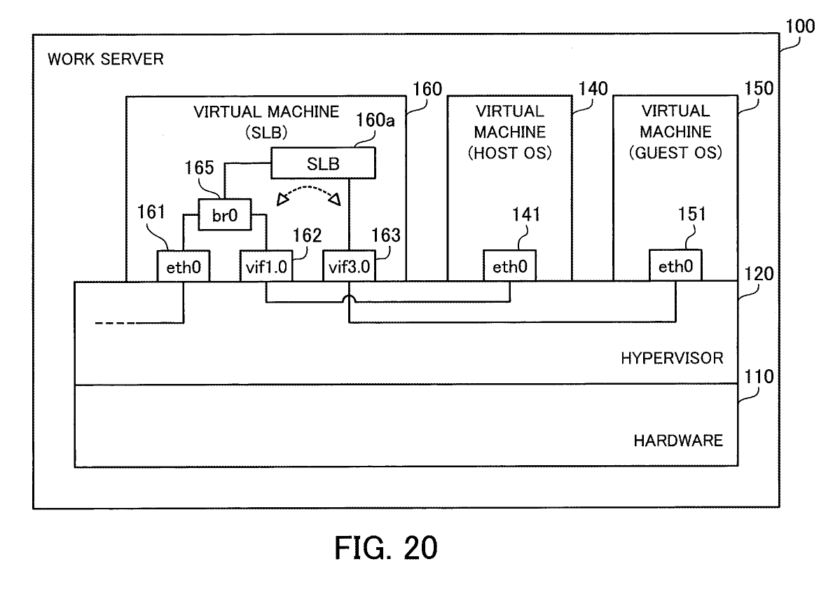

FIG. 20 depicts an example of load balancing after migration. As one example, when performing a rolling update, the hypervisor 120 newly deploys the virtual machine 150 that provides the same services as the virtual machine 140. The virtual machine 150 has a front end driver 151. The front end driver 151 is associated with the identification information “eth0” at the virtual machine 150. Here, a backend driver 163 is also added to the virtual machine 160. The backend driver 163 is connected to the front end driver 151. The backend driver 163 is associated with the identification information “vif3.0”. The virtual machine 160 has an SLB 160a.

The SLB 160a acquires packets via the bridge 165 and performs load balancing. As one example, the SLB 160a performs load balancing using MAC addresses. More specifically, the SLB 160a acquires, from the virtual machine 140, the IP address of the client that accessed the virtual machine 140 from before deployment of the virtual machine 160 (such IP address may be acquired from the hypervisor 120). The SLB 160a assigns packets that have the IP address of the client as the transmission source to the virtual machine 140. Management of the virtual machines 140 and 150 that are the assignment destination is performed using the MAC addresses of the frontend drivers 141 and 151. Here, the IP address of the front end driver 151 may be any address. For example, it is possible to set the front end driver 151 with the same IP address “IP-A” as the frontend driver 141.

Alternatively, the front end driver 151 may be set with an IP address that differs to the frontend driver 141. In such situation, when assigning packets that designate the destination IP address “IP-A”, the SLB converts the destination IP address of the packets to the IP address of the virtual machine 150. When reply packets have been received from the virtual machine 150 in response to such packets, the SLB restores the transmitter IP address to the IP address “IP-A” and transfers the reply packets. In this way, providing redundancy for the function of providing users with services using the virtual machines 140, 150, and 160 makes it possible to perform a rolling update.

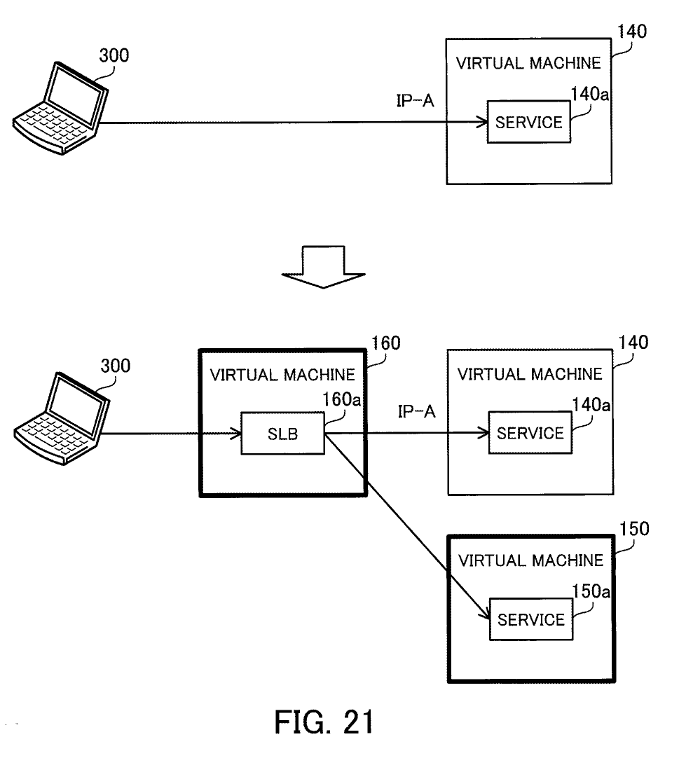

FIG. 21 depicts an example (first example) of SLB deployment. According to the second embodiment, even when the virtual machine 160 that performs load balancing has not been deployed, it is possible to dynamically deploy the virtual machine 160 while maintaining the session information between the client 300 and the virtual machine 140. As one example, the IP address “IP-A” set in the virtual machine 140 is used even after the virtual machine 160 has been deployed.

Here, since the data communicated between the virtual machine 140 and the client 300 is stored in the buffer 121 and the IP address of the virtual machine 140 does not need to be changed, it is possible for the virtual machine 140 to continue to use the session information from before deployment of the virtual machine 160. Accordingly, it is possible to maintain the content of communication between the virtual machine 140 and the client 300, even after deployment of the virtual machine 160. Also, since it is not necessary to relearn the MAC address learning table and the like at the respective switches included on the networks 30 and 40, it is possible to avoid interruptions to the communication between the client 300 and the virtual machine 140 due to relearning by the switches.

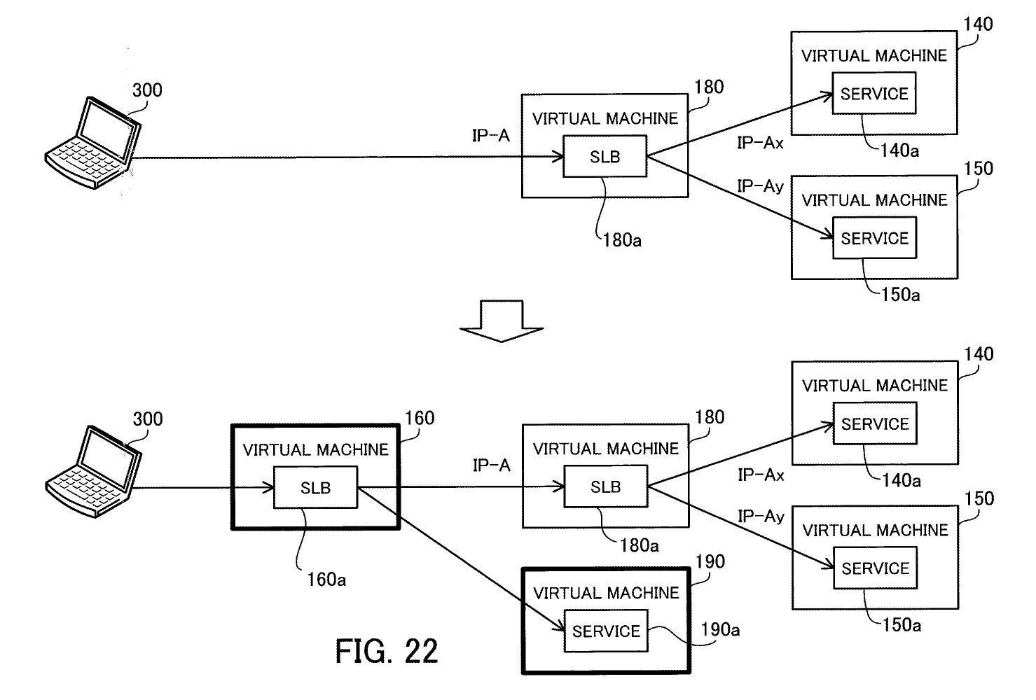

FIG. 22 depicts an example (second example) of SLB deployment. Here, in step S2 of FIG. 14, an example is depicted where a virtual machine 160 with an SLB is newly deployed when the condition that an SLB has been deployed and such SLB permits the control from the manager 137 has not been satisfied. As a specific example, consider a case where a virtual machine 180 with an SLB 80a has been deployed for the virtual machines 140 and 150 but control of the SLB 180a from the manager 137 is not permitted.

Here, since it is not possible for a manager to perform operations to change the settings of the SLB 180a, flow control of packets by the SLB 180a cannot be performed and a rolling update cannot be performed appropriately. In this case, the hypervisor 120 dynamically deploys the virtual machine 160 according to the method in the second embodiment. It is also not necessary to change the IP address of the frontend drivers of the virtual machine 180 (for example, it is possible to use the IP address “IP-A” from before deployment of the virtual machine 160 at the virtual machine 180, even after deployment of the virtual machine 160). The hypervisor 120 additionally runs a virtual machine 190. The virtual machine 190 provides the same service as the services 140a and 150a. The SLB 160a then performs load balancing for the virtual machines 180 and 190. By doing so, it is possible to perform flow control of packets using the SLB 160a, even when it is not possible to perform flow control of packets using the SLB 180a. Accordingly, it is possible to perform an updating operation and the like of software of the virtual machines 140 and 150 while substituting a service 190a for the provided services. In particular, it is possible to maintain the session information of communication between the virtual machines 140 and 150 and the client 300 even after deployment of the virtual machine 160.

Note that after a task such as a rolling update, it is possible to remove the virtual machine 160 that performed the SLB. Next, an example of the removal procedure will be described.

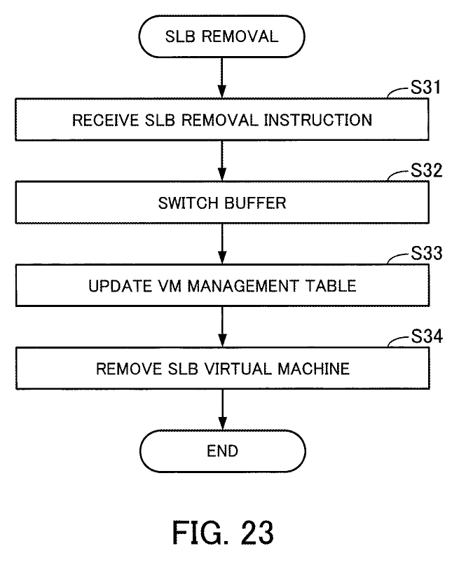

FIG. 23 is a flowchart depicting an example of SLB removal. The processing in FIG. 23 is described below in order of the step numbers.

(S31) The device migration control unit 123 receives a removal instruction for the SLB 160a (the virtual machine 160) or a stop instruction for the virtual machine 160. The device migration control unit 123 then runs the backend driver 132 on the virtual machine 130.

(S32) The buffer switching unit 126 performs buffer switching. The buffer switching unit 126 executes the buffer switching procedure illustrated in FIG. 18 as a case where migration is performed from the backend driver 162 to the backend driver 132. The buffer switching unit 126 sets the access destination of the backend driver 132 at the buffer 121. At this time, the data stored in the buffer 122 may be merged with the buffer 121. Also, by setting the data write destination address of the backend drivers 133 and 162 at the address of the write prohibited region, data writes by the backend drivers 133 and 162 may be trapped and written in the buffer 121. The buffer switching unit 126 updates the network management table 172c. The network management table after updating has the same set content as the network management table 172.

(S33) The device migration control unit 123 updates the VM management table 171b. The updated VM management table has the same set content as the VM management table 171. That is, the VM management table 171 and the network management table 172 are returned to the state before the virtual machine 160 was deployed.

(S34) The device migration control unit 123 removes the virtual machine 160 of the SLB 160a. More specifically, the device migration control unit 123 stops the virtual machine 160 and releases the resources that were assigned to the virtual machine 160 (by setting such resources as available).

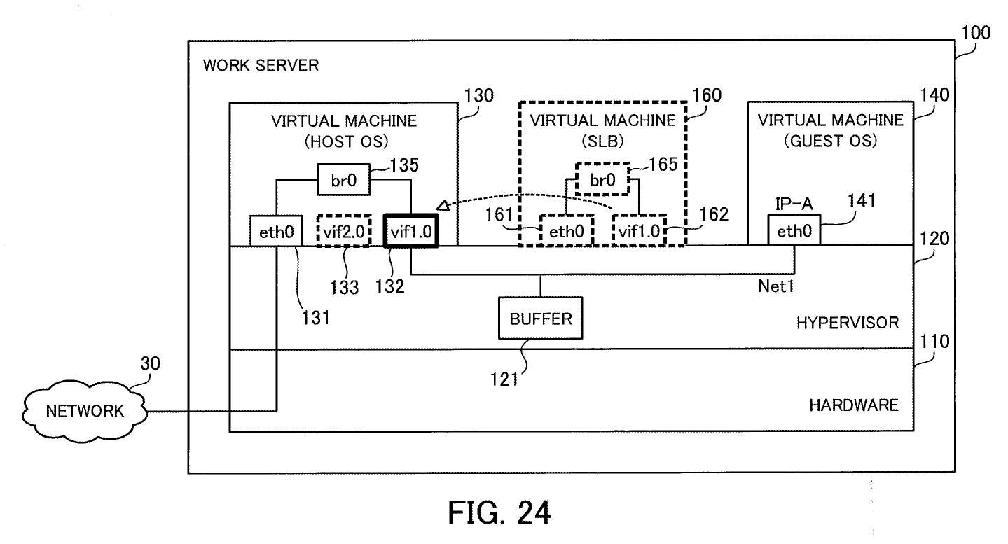

FIG. 24 depicts an example of SLB removal. The hypervisor 120 runs the backend driver 132 on the virtual machine 130 in place of the backend driver 162 of the virtual machine 160. The backend driver 132 shares the buffer 121 with the frontend driver 141 so that communication between the virtual machines 130 and 140 is realized once again. By setting the access destination of the backend driver 132 at the buffer 121, data being transferred between the client 300 and the virtual machine 140 is maintained. Also, by changing the access destination for accesses by the backend drivers 133 and 162 to the address of the prohibited region, writes of data being transferred by the backend drivers 133 and 162 may be trapped so that the data is written into the buffer 121. By doing so, it is possible to also store, in the buffer 121, data that is being transferred but has not yet been written in the buffer 121.

After this, the hypervisor 120 stops the virtual machine 160. Also, the hypervisor 120 deletes the backend driver 133 from the virtual machine 130. By doing so, the hypervisor 120 restores the work server 100 to the state in FIG. 6 (the original state).

However, it would be conceivable to update the software of the virtual machine 140 as follows using the method of the second embodiment.

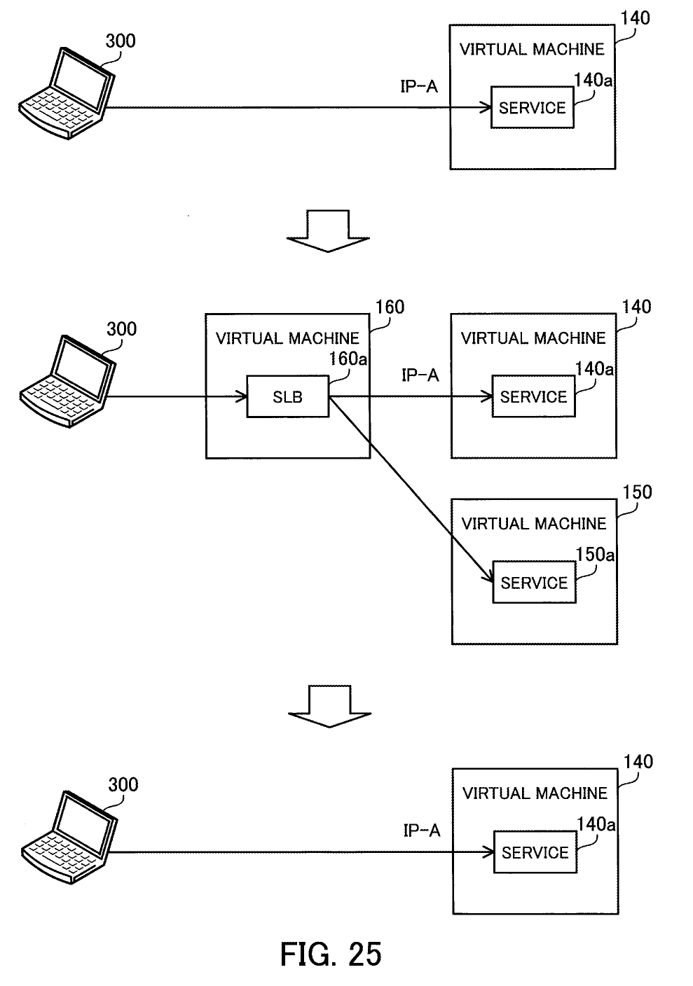

FIG. 25 depicts an example (first example) of an updating method of a virtual machine. First, it is assumed that the client 300 and the virtual machine 140 are communicating and the virtual machines 150 and 160 have not been deployed. When the client 300 and the virtual machine 140 are communicating, the hypervisor 120 receives an updating instruction for the software of the virtual machine 140 (which may correspond to a deployment instruction for the virtual machine 160) from the manager 137.

The hypervisor 120 deploys the virtual machines 150 and 160. The SLB 160a of the virtual machine 160 performs load balancing for the virtual machines 140 and 150. To maintain the communication between the virtual machine 140 and the client 300, the SLB 160a assigns packets from the client 300 to the virtual machine 140. When communication between the virtual machine 140 and the client 300 has been completed, the SLB 160a assigns all of the packets to the virtual machine 150 and does not assign packets to the virtual machine 140.

After this, the hypervisor 120 performs a software updating operation for the virtual machine 140 (as one example, the virtual machine 140 is restarted in a state where updated software has been installed). Even if the virtual machine 140 is temporarily stopped, by substituting the provision of services at the virtual machine 150, it is possible to prevent the provision of services to the user from stopping. After the updating of software of the virtual machine 140, the hypervisor 120 removes the virtual machines 150 and 160.

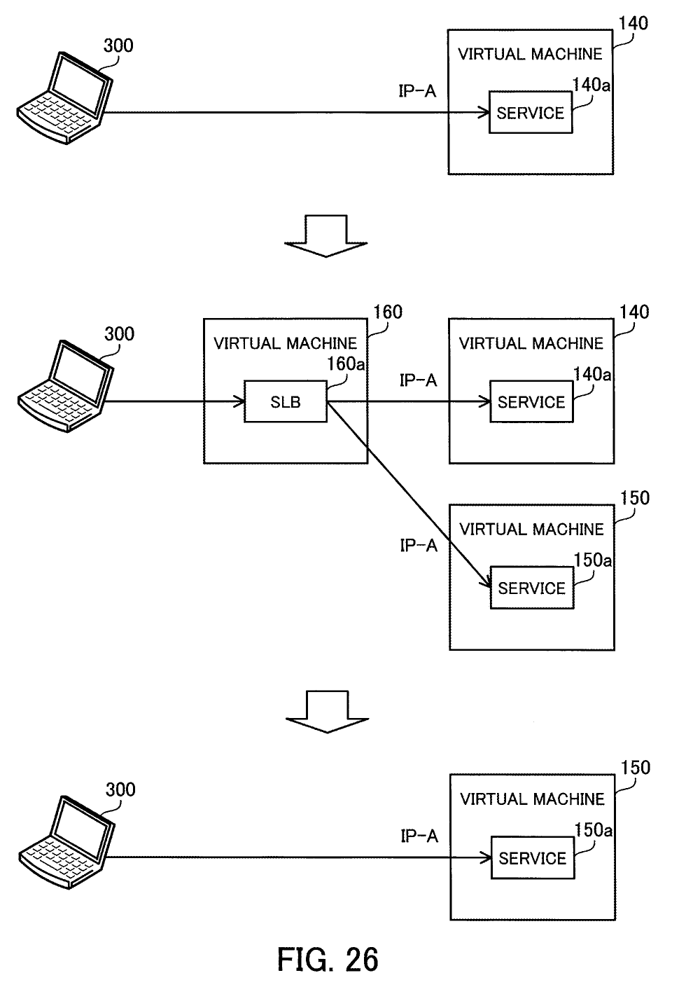

FIG. 26 depicts an example (second example) of an updating method of a virtual machine. First, it is assumed that the client 300 and the virtual machine 140 are communicating and that the virtual machines 150 and 160 have not been deployed. When the client 300 and the virtual machine 140 are communicating, the hypervisor 120 receives an updating instruction for the software of the virtual machine 140 from the manager 137. The hypervisor 120 deploys the virtual machines 150 and 160.

The hypervisor 120 runs the virtual machine 150 in a state with the same specification and the same IP address as the virtual machine 140 and where updated software has been installed.

The SLB 160a of the virtual machine 160 performs load balancing for the virtual machines 140 and 150 by distinguishing between the virtual machines 140 and 150 using the MAC addresses, for example. Since the SLB 160a maintains the communication between the virtual machine 140 and the client 300, packets from the client 300 are assigned to the virtual machine 140. When communication between the virtual machine 140 and the client 300 has been completed, the SLB 160a assigns all of the packets to the virtual machine 150 and does not assign packets to the virtual machine 140. After this, the hypervisor 120 removes the virtual machines 140 and 160. Here, the hypervisor 120 may sets the write destination of the data by the backend driver 133 and the backend driver 163 depicted in FIG. 20 at the prohibited region of the memory to trap the writes. This is because by changing the write destination of the data to a buffer region accessed by the backend driver (used for communication with the virtual machine 150) that has been newly created in the virtual machine 130, it is possible to store data that is being transferred but is yet to be written into a buffer region into the same buffer region.

With the method in FIG. 25, the virtual machine 140 is kept and the virtual machine 150 is removed. On the other hand, the method in FIG. 26 differs in that the virtual machine 150 is kept and the virtual machine 140 is removed. The work server 100 is capable of executing both methods. As one example, with the method in FIG. 25, since the specifications of the virtual machines 140 and 150 do not need to be the same, the specification of the virtual machine 150 can be set higher or lower than the virtual machine 140. That is, there is the advantage that it is possible to adjust the specification of the virtual machine 150 in keeping with the usage state of resources. On the other hand, the method in FIG. 26 omits the procedure of restarting the virtual machine 140 in a state where updated software is used (compared to the method in FIG. 25). This has an advantage in that it is possible to shorten the updating procedure.

Although an example where a backend driver is provided in the host OS has been described above, it is also possible to apply the second embodiment when a backend driver is provided in a virtual machine that functions as a driver OS (or a driver domain). In such situation, a back end driver of the driver domain is migrated to the guest OS in place of the driver domain.

Note that the information processing in the first embodiment can be realized by having the computing unit 11b execute a program. The information processing in the second embodiment can be realized by the processor 101 execute a program. Such programs can be recorded on the computer-readable recording medium 23.

As one example, it is possible to distribute a program by distributing the recording medium 23 on which such program is recorded. It is also possible to store a program in another computer and distribute the program via a network. As examples, a computer may store (install) a program recorded on the recording medium 23 or a program received from another computer in a storage apparatus such as the RAM 102 or the HDD 103 and read out and execute the program from the storage apparatus.

According to the above embodiments, it is possible to dynamically deploy a virtual machine that performs load balancing.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A load balancing function deploying method comprising:
receiving, by a computer, a deployment instruction for a new virtual machine that controls communication between a first virtual machine, which has a function for communicating with at least one virtual machine, and a second virtual machine;
creating, by the computer, a second driver corresponding to a first driver, which is provided in the first virtual machine and is used for communication with the second virtual machine, and a third driver, which is used for communication between the new virtual machine and the first virtual machine, in the new virtual machine;
connecting, by the computer, the second driver and the third driver using a virtual bridge; and
invalidating, by the computer, the first driver and validating the second driver after enabling the second driver to use a buffer region used by the first driver.

2. The load balancing function deploying method according to claim 1, further comprising
detecting a write of data by the first driver and changing a write destination of the data to the buffer region of the second driver.

3. The load balancing function deploying method according to claim 2,
wherein the detecting includes setting the write destination of data to be written by the first driver to an address for which data writes from the first driver are prohibited to cause an interrupt when there is a write by the first driver.

4. The load balancing function deploying method according to claim 1,
wherein the new virtual machine is a virtual machine that executes load balancing for a plurality of virtual machines including the second virtual machine.

5. The load balancing function deploying method according to claim 4,
wherein an IP address of the second virtual machine has a same content before deployment and after deployment of the new virtual machine.

6. The load balancing function deploying method according to claim 5,
wherein a plurality of virtual machines are set with the IP address of the second virtual machine.

7. The load balancing function deploying method according to claim 1, further comprising
creating, by the computer, upon receiving a removal instruction for the new virtual machine, the first driver in the first virtual machine, enabling the created first driver to use the buffer region used by the second driver, and stopping the new virtual machine after starting communication between the first virtual machine and the second virtual machine.

8. The load balancing function deploying method according to claim 1,
wherein the first virtual machine is a virtual machine that controls access to hardware of the computer by another virtual machine, and
the first driver and the second driver are backend drivers that communicate with the second virtual machine.

9. A load balancing function deploying apparatus comprising:
a memory including a buffer region storing data communicated by virtual machines; and
a processor configured to perform a procedure including:
receiving a deployment instruction for a new virtual machine that controls communication between a first virtual machine, which has a function for communicating with at least one virtual machine, and a second virtual machine;
creating a second driver corresponding to a first driver, which is provided in the first virtual machine and is used for communication with the second virtual machine, and a third driver, which is used for communication between the new virtual machine and the first virtual machine, in the new virtual machine;
connecting the second driver and the third driver using a virtual bridge; and
invalidating the first driver and validating the second driver after enabling the second driver to use a buffer region used by the first driver.

10. A non-transitory computer-readable storage medium storing a load balancing function deploying program, the load balancing function deploying program causing a computer to perform a procedure comprising:
receiving a deployment instruction for a new virtual machine that controls communication between a first virtual machine, which has a function for communicating with at least one virtual machine, and a second virtual machine;
creating a second driver corresponding to a first driver, which is provided in the first virtual machine and is used for communication with the second virtual machine, and a third driver, which is used for communication between the new virtual machine and the first virtual machine, in the new virtual machine;
connecting the second driver and the third driver using a virtual bridge; and
invalidating the first driver and validating the second driver after enabling the second driver to use a buffer region used by the first driver.
